(19) United States
(12) Patent Application Publication
(10) Pub. No.: US 2024/0361825 A1
(43) Pub. Date: Oct. 31, 2024

(54) WORK SUPPORT APPARATUS, WORK SUPPORT METHOD, AND COMPUTER-READABLE RECORDING MEDIUM

(71) Applicant: Yokogawa Electric Corporation, Tokyo (JP)

(72) Inventors: Motohiko ISHIDA, Tokyo (JP); Hideo UEMURA, Tokyo (JP); Kenji OISHI, Tokyo (JP); Takashi TSUBOTA, Tokyo (JP)

(21) Appl. No.: 18/640,608

(22) Filed: Apr. 19, 2024

(30) Foreign Application Priority Data
Apr. 27, 2023 (JP) 2023-073319

(51) Int. Cl. G06F 3/01; G06F 18/245

(52) U.S. Cl. CPC G06F 3/011; G06F 18/245

(57) ABSTRACT

A work support server is a work support apparatus and acquires biological data on plural workers who engage in shared work for operation of a plant, estimates a state of each of the plural workers on the basis of the biological data on the plural workers, makes an analysis of a state of each of the plural workers, and determines, on the basis of a result of the analysis, whether or not intervention in the shared work by the work support apparatus is necessary.

### CROSS-REFERENCE TO RELATED APPLICATION

The present application claims priority to and incorporates by reference the entire contents of Japanese Patent Application No. 2023-073319 filed in Japan on Apr. 27, 2023.

### FIELD

The present invention relates to a work support apparatus, a work support method, and a computer-readable recording medium.

### BACKGROUND

In a technique conventionally available for plants, feedback based on biological data on workers is given to the workers and feedback based on operation data on the plants is given to apparatuses and devices (“plant devices” as appropriate) installed in the plants.

However, with the conventional technique, it is difficult to present a more appropriate work environment according to a physical or psychological state of the workers. For example, in the conventional technique, targets to be operated by the workers are temporally unchanged even though operation of some plant devices can be dangerous and handling of some plant devices requires full concentration. That is, in the conventional technique, the operating environment is not changed to be adapted to the workers according to states of the workers.

### SUMMARY

According to an aspect of the embodiments, a work support apparatus, includes an acquisition unit that acquires biological data on plural workers who engage in shared work related to operation of a plant, an analysis unit that estimates a state of each of the plural workers on the basis of the biological data on the plural workers and makes an analysis of the state of each of the plural workers, and a decision unit that determines, on the basis of a result of the analysis by the analysis unit, whether or not intervention in the shared work by the work support apparatus is necessary.

According to an aspect of the embodiments, a work support method executed by a work support apparatus, the work support method includes an acquisition process of acquiring biological data on plural workers who engage in shared work related to operation of a plant, an analysis process of estimating a state of each of the plural workers on the basis of the biological data on the plural workers and making an analysis of the state of each of the plural workers, and a determination process of determining, on the basis of a result of the analysis made through the analysis process, whether or not intervention in the shared work by the work support apparatus is necessary.

According to an aspect of the embodiments, a computer-readable recording medium having stored therein a work support program that causes a work support apparatus to execute a process includes an acquisition step of acquiring biological data on plural workers who engage in shared work related to operation of a plant, an analysis step of estimating a state of each of the plural workers on the basis of the biological data on the plural workers and making an analysis of the state of each of the plural workers, and a determination step of determining, on the basis of a result of the analysis made through the analysis step, whether or not intervention in the shared work by the work support apparatus is necessary.

### BRIEF DESCRIPTION OF THE DRAWINGS

FIG. 1 is a diagram illustrating an example of a configuration of a work support system according to an embodiment;

FIG. 2 is a block diagram illustrating an example of a configuration of each apparatus according to the embodiment;

FIG. 3 is a diagram illustrating an example of a work environment data storage unit in a work support server according to the embodiment;

FIG. 4 is a diagram illustrating an example of a work data storage unit in the work support server according to the embodiment;

FIG. 5 is a diagram illustrating an example of a biological data storage unit in the work support server according to the embodiment;

FIG. 6 is a diagram illustrating an example of an operation data storage unit in the work support server according to the embodiment;

FIG. 7 is a diagram illustrating an example of a group data storage unit in the work support server according to the embodiment;

FIG. 8 is a diagram illustrating an example of a correspondence relation data storage unit in the work support server according to the embodiment;

FIG. 9 is a diagram illustrating an example of an intervention data storage unit in the work support server according to the embodiment;

FIG. 10 is a diagram illustrating an example of the intervention data storage unit in the work support server according to the embodiment;

FIG. 11 is a diagram illustrating a first specific example of a state estimation process according to the embodiment;

FIG. 12 is a diagram illustrating a second specific example of the state estimation process according to the embodiment;

FIG. 13 is a diagram illustrating a specific example of a display screen according to the embodiment;

FIG. 14 is a flowchart illustrating an example of an overall flow of a work support process according to the embodiment;

FIG. 15 is a flowchart illustrating an example of a flow of a data acquisition process according to the embodiment;

FIG. 16 is a flowchart illustrating an example of a flow of a worker classification process according to the embodiment;

FIG. 17 is a flowchart illustrating an example of a flow of a data analysis process according to the embodiment;

FIG. 18 is a flowchart illustrating an example of a flow of an intervention determination process according to the embodiment;

FIG. 19 is a flowchart illustrating an example of a flow of an intervention execution process according to the embodiment; and

FIG. 20 is a diagram illustrating an example of a hardware configuration.

### DESCRIPTION OF EMBODIMENTS

A work support apparatus, a work support method, and a computer-readable recording medium, according to an embodiment of the present invention will hereinafter be described in detail by reference to the drawings. The present invention is not intended to be limited by the embodiment described hereinafter.

### EMBODIMENT

A configuration of a work support system according to an embodiment, a configuration of each apparatus, and flows of processes will hereinafter be described in order and effects of the embodiment will be described lastly.

### 1. Configuration of Work Support System 100

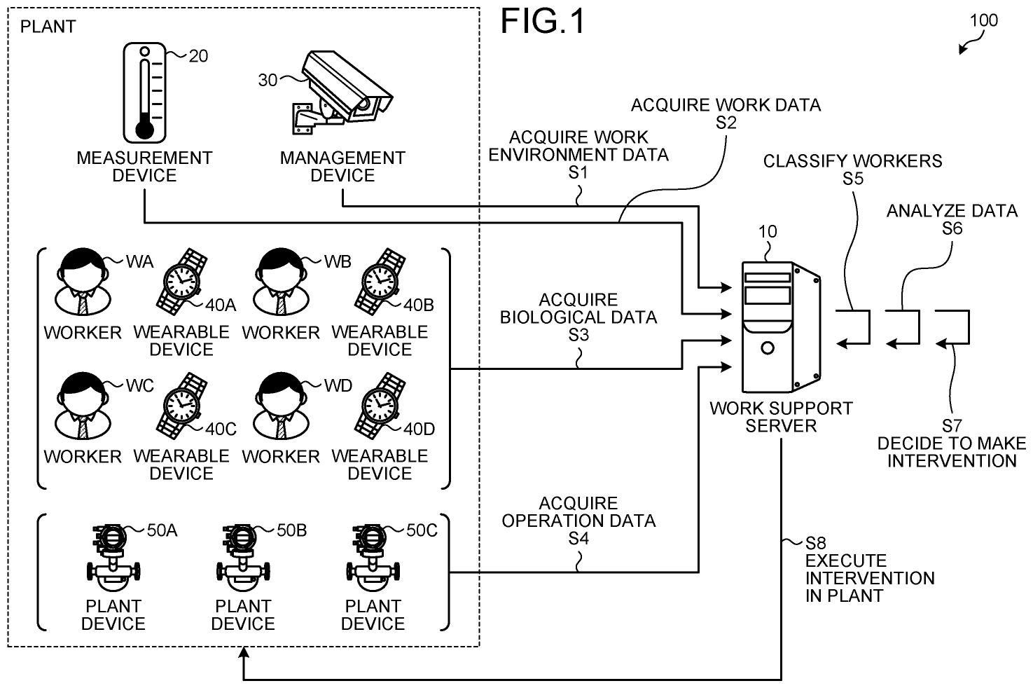

A configuration of a work support system 100 according to the embodiment will be described in detail by use of FIG. 1. FIG. 1 is a diagram illustrating an example of the configuration of the work support system 100 according to the embodiment. An example of an overall configuration of the work support system 100, processes by the work support system 100, and problems of reference techniques will hereinafter be described in order, and effects of the work support system 100 will be described lastly. A work support process in a plant will be described as an example with respect to this embodiment, but the example is not intended to limit devices and fields of application.

### 1-1. Example of Overall Configuration of Work Support System 100

The work support system 100 has a work support server 10 that is a work support apparatus, a measurement device 20, a management device 30, wearable devices 40 (40A, 40B, 40C, and 40D) worn by workers W (WA, WB, WC, and WD) in the plant, and plant devices 50 (50A, 50B, and 50C). The work support server 10 is communicably connected to the measurement device 20, the management device 30, the wearable devices 40, and the plant devices 50 by wire or wirelessly via a predetermined communication network not illustrated in the drawings. Furthermore, the measurement device 20, the management device 30, the wearable devices 40, and the plant devices 50 are installed in the plant.

The work support system 100 illustrated in FIG. 1 may include a plurality of the work support servers 10, a plurality of the measurement devices 20, or a plurality of the management devices 30. Furthermore, two or more selected from a group including the measurement device 20, the management device 30, the wearable devices 40, and the plant devices 50 may be configured to be integrated together.

### 1-2. Overall Process by Work Support System 100

The following description is on the overall process performed by the work support system 100 described above. Steps S1 to S8 described below may be executed in a different sequence. Furthermore, any of Steps S1 to S8 described below may be omitted.

### 1-2-1. Work Environment Data Acquisition Process

The work support server 10 acquires work environment data from the measurement device 20 installed in the plant (Step S1). For example, the work support server 10 acquires work environment data on air temperature, humidity, sound, brightness, or odor, for example, in each area of the plant, from the measurement device 20, such as a thermometer or a hygrometer.

### 1-2-2. Work Data Acquisition Process

The work support server 10 acquires work data from the management device 30 (Step S2). For example, the work support server 10 acquires work data for each worker W, the work data being on a roster, a worker ID, a work location, an operated device, and a video from a line-of-sight camera on the worker W, for example, from the management device 30, such as a PC or a camera.

### 1-2-3. Biological Data Acquisition Process

The work support server 10 acquires biological data from the wearable devices 40 worn by the workers W (Step S3). For example, the work support server 10 acquires biological data on a pulse, heartbeat, skin electric potential, myoelectric potential, eye electric potential, brain waves, cerebral blood flow, an expression, a tone of voice, and a blood sugar level, for example, for each of the workers W, from the wearable devices 40, such as smart watches.

### 1-2-4. Operation Data Acquisition Process

The work support server 10 acquires operation data from the plant devices 50 installed in the plant (Step S4). For example, the work support server 10 acquires physical operation data used in control of the plant from the plant devices 50, such as a tank, a pipe, and a furnace, the physical operation data being on, for example, pressure of fluid or solid, a flow velocity, temperature, and a liquid level.

### 1-2-5. Worker Classification Process

The work support server 10 classifies the workers W who engage in shared work (Step S5). For example, the work support server 10 determines a work process for each worker W from the work environment data and the work data and classifies the workers W by shared work process. In the example of FIG. 1, the work support server 10 classifies the worker WA, the worker WC, and the worker WD into a work process 1, and classifies the worker WB into a work process 2.

### 1-2-6. Data Analysis Process

The work support server 10 analyzes the data that have been acquired (Step S6). For example, the work support server 10 estimates a state of each worker W from the biological data and detects any abnormality in the workers W for each shared work process. In the example of FIG. 1, the work support server 10 detects abnormality in the workers W for the work process 1 in a case where all of the worker WA, the worker WC, and the worker WD classified into the work process 1 are in a “hasty” state.

1-2-7. Intervention determination process

The work support server 10 decides to make an intervention in the plant (Step S7). For example, in a case where abnormality has been detected in the workers W, the work support server 10 decides to make an intervention by a notification to present a work instruction to the workers W or by a notification to restrict work of the workers W. The work support server 10 may predict time evolution of an evaluation index, such as a process value for a case where the intervention is executed and determine whether or not the intervention is necessary or determine an intervention means.

### 1-2-8. Intervention Execution Process

The work support server 10 executes an intervention in the plant (Step S8). For example, the work support server 10 makes a notification to the wearable devices 40 of the workers W or executes control of the plant devices 50 to change their process values to safer values. In the example of FIG. 1, the work support server 10 decides to make an intervention by a notification to present a work instruction to the worker WA and worker WC, whose “haste” levels are low and a notification to restrict work of the worker WD, whose “haste” level is high, and executes control of the plant device 50A operated by the worker WD.

### 1-3. Problems in Work Support Processes of Reference Techniques

The following description is on problems in work support processes of reference techniques described in Japanese Patent No. 6192885, Japanese Patent Application Publication No. 2020-161187 and Japanese Patent Application Publication No. 2020-099019.

### 1-3-1. Problem in Work Support Process of Japanese Patent No. 6192885

In a technique proposed for a work support process described in Japanese Patent No. 6192885, workloads on workers are assessed by association between behavior information and biological information and a warning is given. However, this work support process has a problem that the biological information measured is just utilized in abnormality detection and warning display, and the operating environment of the workers cannot be changed appropriately on the basis of the biological information measured.

### 1-3-2. Problem in Work Support Process of Japanese Patent Application Publication No. 2020-161187

In a technique proposed for a work support process described in Japanese Patent Application Publication No. 2020-161187, “preventive intervention action likely to contribute to maintenance or improvement of health” is performed by use of biological information. However, this work support process has a problem that the target to be given feedback using the biological information is humans and feedback cannot be given to apparatuses and devices.

### 1-3-3. Problem in Work Support Process of Japanese Patent Application Publication No. 2020-099019

A device control apparatus proposed for a work support process described in Japanese Patent Application Publication No. 2020-099019 includes a control mode changer that changes the control mode on the basis of biological information on workers, their work environment, and operation data on facilities of, for example, a thermal power station. However, in this work support process, the biological data are on humans having a vast number of explanatory variables and thus fluctuate more largely and are lower in measurement precision than measured physical quantities that are clearly characterized. Therefore, this work support process has a problem in terms of actual operation, the problem being that the biological data are not an ideal basis for judgment in a case where a lot of damage may be caused if feedback based on the biological data is erroneous.

### 1-4. Effects of Work Support System 100

In the above mentioned work support processes of the reference techniques, the targets to be operated by the workers are temporally unchanged and their operating environment will not be changed to be adapted to the workers in accordance with states of the workers. Therefore, the work support processes of the reference techniques do not provide a system where a more appropriate operating environment (work environment) is presented in accordance with a physical or psychological state of the workers. However, operation of some devices and apparatuses is dangerous and handling of some devices and apparatuses requires full concentration. Therefore, changing the operability of devices and apparatuses in accordance with the power of concentration and attention levels of users may enable safe and comfortable use of the devices and apparatuses. For example, in a case where a user is not paying close attention, irreversible operation may be restricted or the operation speed of a device may be decreased to prevent a dangerous situation, such as an accident, from being caused.

What is proposed is to make an intervention, such as immediate feedback to a human or feedback to a device, by estimating a physical or psychological state of the workers W from biological data measured using the various wearable device 40, in the work support system 100.

In the work support system 100, examples of targets to be measured by the wearable devices 40 include pulses, heartbeat, skin electric potential, myoelectric potential, eye electric potential, brain waves, cerebral blood flow, expressions, tones of voice, and blood sugar levels, but without being limited to these examples, the examples of targets include various biological data for estimation of a physical or psychological state.

For the work support system 100, examples of change made to the operating environment include the following examples, which are just examples, and the examples of change are not limited to the following examples. For example, the operation speed of operation requiring attention in adjustment, such as maneuvering of a robot arm, is decreased, the specifications are changed so that operation involving judgment that may cause a lot of damage if the judgment is wrong is restricted or so that the operation requires confirmation a plural number of times, or a workload on a worker carrying out line work, for example, is temporarily reduced to an amount of work that the worker is capable of handling at that time point. Alternatively, for example, when a worker W is concentrating, a normal operation screen is maintained, and when the worker W is inattentive, irreversible operation is restricted or the operation screen is changed to a simpler one. The work support system 100 is expected to induce correct operation by such change and reduce erroneous operation.

The above described work support system 100 is applicable to all sorts of devices and apparatuses that require human operation. In particular, the work support system 100 is able to be introduced to, for example, a plant where one mistake made by a worker W results in a lot of damage.

A proposal similar to that for the work support system 100 described above has been made, that is, a proposal to give feedback (work support and an alert, for example) to a human by using operation data and biological data, or a proposal to implement optimized control by giving feedback to a device or a system has been made. However, as compared to physical measured quantities, biological data have not been used in situations where erroneous judgments can cause significant damage because of ambiguity of the biological data. That is, improving the probability of judgments using biological data is needed for utilization of the biological data in such situations.

Therefore, in the work support system 100, the following approach is proposed to improve the probability of a judgment using operation data and biological data. Firstly, in the work support system 100, by combining operation data with biological data on plural workers W who engage in work similar to one another, internal aspects of the workers W and an environment faced by the workers W are accurately estimated, and in a case where the workers W are determined to be in an abnormal state, appropriate feedback is given to humans or appropriate feedback is given to a device or a system. Secondly, in the work support system 100, a simulation is made with a judgment result using a state determined by operation data and biological data (a digital twin is created or time evolution from the state is predicted from a past history), and only a judgment that causes the operation state to transition to a better state is adopted. Thirdly, in the work support system 100, precision of the prediction is increased by combination of plural pieces of biological data. As described above, in the work support system 100, a more appropriate work environment is able to be presented in accordance with a physical or psychological state of the workers W.

### 2. Configuration of Each Apparatus in Work Support System 100

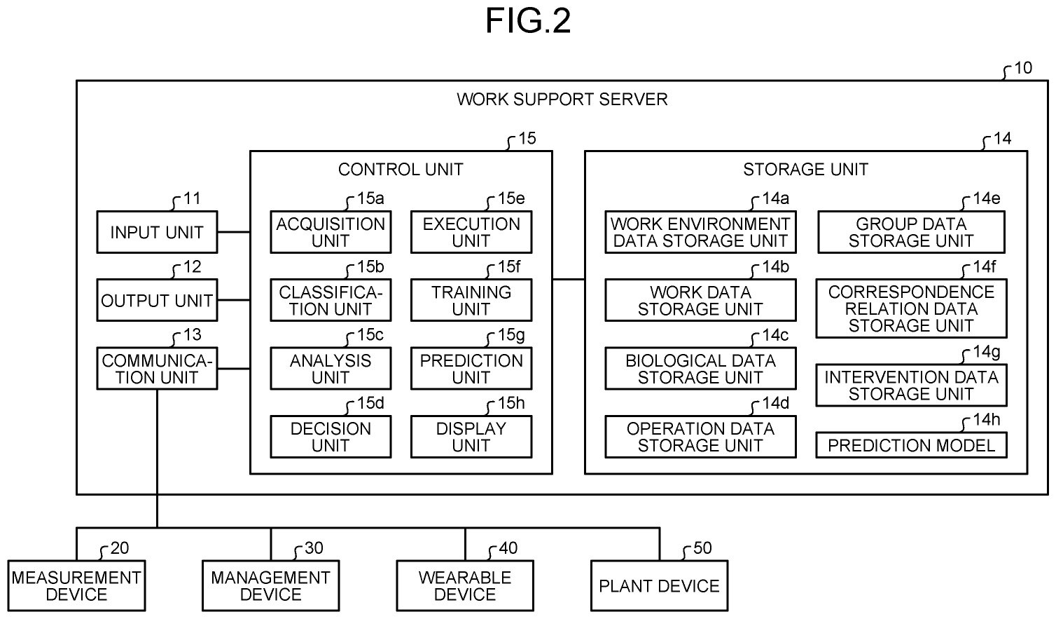

A functional configuration of each apparatus that the work support system 100 illustrated in FIG. 1 has will be described by use of FIG. 2. FIG. 2 is a block diagram illustrating an example of a configuration of each apparatus according to the embodiment. Hereinafter, an example of the overall configuration of the work support system 100 according to the embodiment will be described, and examples of configurations of the work support server 10, the measurement device 20, the management device 30, the wearable devices 40, and the plant devices 50 according to the embodiment will thereafter be described in detail.

### 2-1. Example of Overall Configuration of Work Support System 100

As illustrated in FIG. 2, the work support system 100 has the work support server 10, the measurement device 20, the management device 30, the wearable devices 40, and the plant devices 50. The work support server 10 is communicably connected to the measurement device 20, the management device 30, the wearable devices 40, and the plant devices 50, by a predetermined communication network.

### 2-2. Example of Configuration of Work Support Server 10

An example of the configuration of the work support server 10 that is a work support apparatus will be described first by use of FIG. 2. The work support server 10 has an input unit 11, an output unit 12, a communication unit 13, a storage unit 14, and a control unit 15.

### 2-2-1. Input Unit 11

The input unit 11 governs input of various kinds of information to the work support server 10. For example, the input unit 11 is implemented by a mouse and a keyboard, and receives input of, for example, setting information to the work support server 10.

### 2-2-2. Output Unit 12

The output unit 12 governs display of various kinds of information from the work support server 10. For example, the output unit 12 is implemented by a display and displays setting information stored in the work support server 10.

### 2-2-3. Communication Unit 13

The communication unit 13 governs data communication with another apparatus. For example, the communication unit 13 performs data communication with each communication apparatus via a router. Furthermore, the communication unit 13 is capable of performing data communication with a terminal of an operator not illustrated in the drawings.

### 2-2-4. Storage Unit 14

The storage unit 14 stores various kinds of information referred to for the control unit 15 to operate and various kinds of information acquired for the control unit 15 to operate. The storage unit 14 has a work environment data storage unit 14a, a work data storage unit 14b, a biological data storage unit 14c, an operation data storage unit 14d, a group data storage unit 14e, a correspondence relation data storage unit 14f, an intervention data storage unit 14g, and a prediction model 14h. The storage unit 14 may be implemented by, for example, a semiconductor memory element, such as a random access memory (RAM) or a flash memory, or a storage device, such as a hard disk or an optical disk. In the example of FIG. 2, the storage unit 14 is installed in the work support server 10, but the storage unit 14 may be installed outside the work support server 10 or plural storage units may be installed.

### 2-2-4-1. Work Environment Data Storage Unit 14a

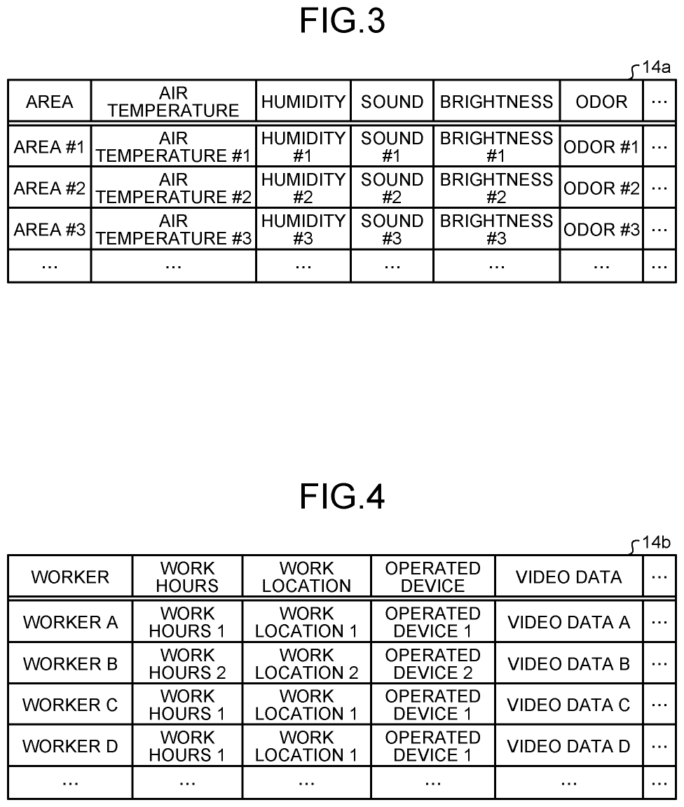

The work environment data storage unit 14a stores work environment data transmitted from the measurement device 20. An example of data stored in the work environment data storage unit 14a will now be described by use of FIG. 3. FIG. 3 is a diagram illustrating an example of the work environment data storage unit 14a in the work support server 10 according to the embodiment. In the example of FIG. 3, the work environment data storage unit 14a has items, such as “area”, “air temperature”, “humidity”, “sound”, “brightness”, and “odor”.

“Area” indicates identification information for identifying a location where work in the plant is carried out, and is, for example, a number for a section in the plant or an identification number of a work process. “Air temperature” indicates an air temperature of each area in the plant and is expressed in, for example, Celsius, ° C. “Humidity” indicates humidity in each area of the plant and is expressed in, for example, percentage, %. “Sound” indicates loudness of sound in each area of the plant and is expressed in, for example, decibels, dB. “Brightness” indicates brightness in each area of the plant, and is expressed in, for example, lux, 1x. “Odor” indicates intensity of odor in each area of the plant, and is expressed, for example, as an odor concentration in parts per million, ppm.

That is, FIG. 3 illustrates an example where: an area of the plant identified by “area #1” has an air temperature of “air temperature #1”, humidity of “humidity #1”, sound of “sound #1”, brightness of “brightness #1”, and odor of “odor #1”; an area of the plant identified by “area #2” has an air temperature of “air temperature #2”, humidity of “humidity #2”, sound of “sound #2”, brightness of “brightness #2”, and odor of “odor #2”; and an area of the plant identified by “area #3” has an air temperature of “air temperature #3”, humidity of “humidity #3”, sound of “sound #3”, brightness of “brightness #3”, and odor of “odor #3”.

### 2-2-4-2. Work Data Storage Unit 14b

The work data storage unit 14b stores work data transmitted from the management device 30. An example of data stored in the work data storage unit 14b will now be described by use of FIG. 4. FIG. 4 is a diagram illustrating an example of the work data storage unit 14b in the work support server 10 according to the embodiment. In the example of FIG. 4, the work data storage unit 14b has items, such as “worker”, “work hours”, “work location”, “operated device”, and “video data”.

“Worker” indicates identification information for identifying a worker W who engages in work in the plant. “Work hours” indicates hours that a worker W engages in work for, and is for example, a work starting time, a break starting time, a break finishing time, and a work finishing time. “Work location” indicates a work process that a worker W engages in, and is, for example, an identification number of the work process. “Operated device” indicates a device operated when a worker W engages in work and is, for example, an identification number of that plant device 50. “Video data” indicates moving image data having a work situation of a worker W captured therein, and is, for example, moving image data captured by a camera worn by the worker W or a camera installed in the plant.

That is, FIG. 4 illustrates an example where: for the worker WA identified by “worker A”, the work hours are “work hours 1”, the work location is “work location 1”, the operated device is “operated device 1”, and the video data are “video data A”; for the worker WB identified by “worker B”, the work hours are “work hours 2”, the work location is “work location 2”, the operated device is “operated device 2”, and the video data are “video data B”; for the worker WC identified by “worker C”, the work hours are “work hours 1”, the work location is “work location 1”, the operated device is “operated device 1”, and the video data are “video data C”; and for the worker WD identified by “worker D”, the work hours are “work hours 1”, the work location is “work location 1”, the operated device is “operated device 1”, and the video data are “video data D”.

### 2-2-4-3. Biological Data Storage Unit 14c

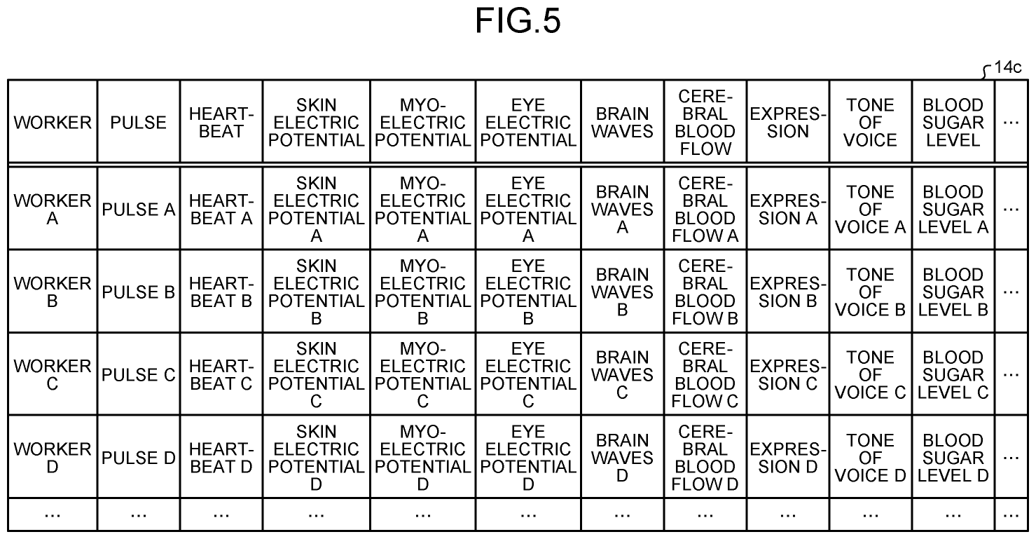

The biological data storage unit 14c stores biological data transmitted from the wearable devices 40. An example of data stored in the biological data storage unit 14c will now be described by use of FIG. 5. FIG. 5 is a diagram illustrating an example of the biological data storage unit 14c in the work support server 10 according to the embodiment. In the example of FIG. 5, the biological data storage unit 14c has items, such as “worker”, “pulse”, “heartbeat”, “skin electric potential”, “myoelectric potential”, “eye electric potential”, “brain waves”, “cerebral blood flow”, “expression”, “tone of voice”, and “blood sugar level”.

“Worker” indicates identification information for identifying a worker W who engages in work in the plant and is, for example, an identification number of the worker W. “Pulse” indicates a pulse of a worker W engaging in work and is, for example, a pulse count per minute. “Heartbeat” indicates a heartbeat of a worker W engaging in work and is, for example, the number of heart beats per minute. “Skin electric potential” indicates skin electric potential in a worker W engaging in work and is, for example, skin electrogram data on the worker W engaging in work. “Myoelectric potential” indicates myoelectric potential in a worker W engaging in work and is, for example, electromyogram data on the worker W engaging in work. “Eye electric potential” indicates eye electric potential in a worker W engaging in work and is, for example, electrooculogram data on the worker W engaging in work. “Brain waves” indicates brain waves of a worker W engaging in work and is, for example, electroencephalogram data on the worker W engaging in work. “Cerebral blood flow” indicates cerebral blood flow of a worker W engaging in work and is, for example, an amount of cerebral blood flow per minute. “Expression” indicates an expression on the face of a worker W engaging in work and is, for example, image data on the face of the worker W. “Tone of voice” indicates a tone of voice of a worker W engaging in work and is, for example, voice data on voice of the worker W. “Blood sugar level” indicates a blood sugar level in a worker W engaging in work and is, for example, a glucose concentration in blood of the worker W.

That is, FIG. 5 illustrates an example where: the worker WA identified by “worker A” has a pulse of “pulse A”, heartbeat of “heartbeat A”, skin electric potential of “skin electric potential A”, myoelectric potential of “myoelectric potential A”, eye electric potential of “eye electric potential A”, brain waves of “brain waves A”, cerebral blood flow of “cerebral blood flow A”, an expression of “expression A”, a tone of voice of “tone of voice A”, and a blood sugar level of “blood sugar level A”; the worker WB identified by “worker B” has a pulse of “pulse B”, heartbeat of “heartbeat B”, skin electric potential of “skin electric potential B”, myoelectric potential of “myoelectric potential B”, eye electric potential of “eye electric potential B”, brain waves of “brain waves B”, cerebral blood flow of “cerebral blood flow B”, an expression of “expression B”, a tone of voice of “tone of voice B”, and a blood sugar level of “blood sugar level B”; the worker WC identified by “worker C” has a pulse of “pulse C”, heartbeat of “heartbeat C”, skin electric potential of “skin electric potential C”, myoelectric potential of “myoelectric potential C”, eye electric potential of “eye electric potential C”, brain waves of “brain waves C”, cerebral blood flow of “cerebral blood flow C”, an expression of “expression C”, a tone of voice of “tone of voice C”, and a blood sugar level of “blood sugar level C”; and the worker WD identified by “worker D” has a pulse of “pulse D”, heartbeat of “heartbeat D”, skin electric potential of “skin electric potential D”, myoelectric potential of “myoelectric potential D”, eye electric potential of “eye electric potential D”, brain waves of “brain waves D”, cerebral blood flow of “cerebral blood flow D”, an expression of “expression D”, a tone of voice of “tone of voice D”, and a blood sugar level of “blood sugar level D”.

### 2-2-4-4. Operation Data Storage Unit 14d

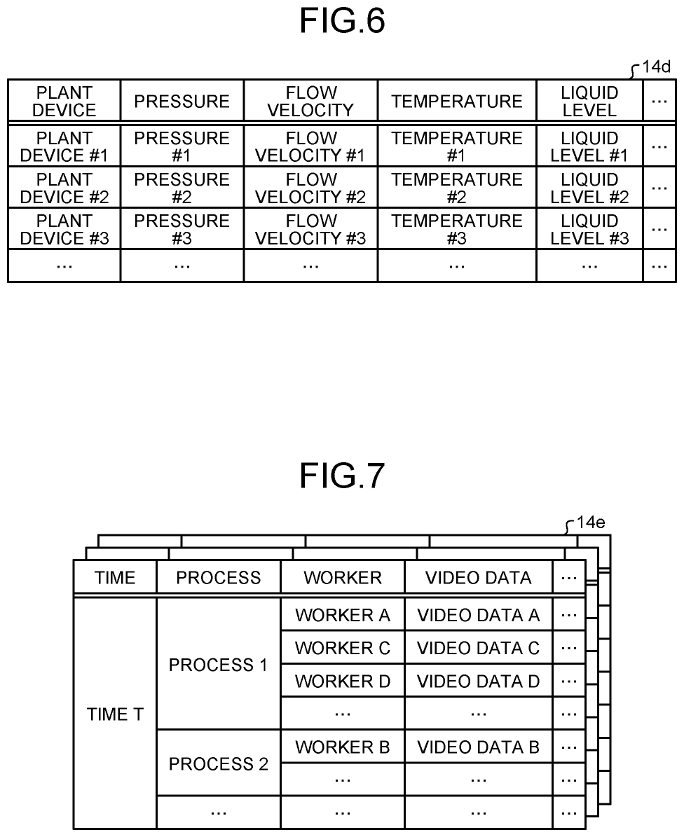

The operation data storage unit 14d stores operation data transmitted from the plant devices 50. An example of data stored in the operation data storage unit 14d will now be described by use of FIG. 6. FIG. 6 is a diagram illustrating an example of the operation data storage unit 14d in the work support server 10 according to the embodiment. In the example of FIG. 6, th operation data storage unit 14d has items, such as “plant device”, “pressure”, “flow velocity”, “temperature”, and “liquid level”.

“Plant device” indicates identification information for identifying a plant device 50 installed in the plant and is, for example, an identification number of the plant device 50. “Pressure” indicates liquid or gas pressure data transmitted from a plant device, such as a manometer, and is expressed in, for example, pascals, Pa. “Flow velocity” indicates liquid or gas flow velocity data transmitted from a plant device 50, such as a flow velocimeter, and is expressed in, for example, meters per second, m/s. “Temperature” indicates liquid or gas temperature data transmitted from a plant device, such as a thermometer, and is expressed in, for example, Celsius, ° C. “Liquid level” indicates data on a height of a boundary surface of liquid, the data having been transmitted from a plant device 50, such as a level gauge, and is expressed in, for example, meters, m.

That is, FIG. 6 illustrates an example where: for a plant device 50 identified by “plant device #1”, the pressure is “pressure #1”, the flow velocity is “flow velocity #1”, the temperature is “temperature #1”, and the liquid level is “liquid level #1”; for a plant device 50 identified by “plant device #2”, the pressure is “pressure #2”, the flow velocity is “flow velocity #2”, the temperature is “temperature #2”, and the liquid level is “liquid level #2”; and for a plant device 50 identified by “plant device #3”, the pressure is “pressure #3”, the flow velocity is “flow velocity #3”, the temperature is “temperature #3”, and the liquid level is “liquid level #3”.

### 2-2-4-5. Group Data Storage Unit 14e

The group data storage unit 14e stores group data generated by a classification unit 15b. An example of data stored in the group data storage unit 14e will now be described by use of FIG. 7. FIG. 7 is a diagram illustrating an example of the group data storage unit 14e in the work support server 10 according to the embodiment. In the example of FIG. 7, the group data storage unit 14e has items, such as “time”, “process”, “worker”, and “video data”.

“Time” indicates a time when workers W classified as a group engage in work and is expressed by, for example, the hour and minutes. “Process” indicates a work process that workers W classified as a group engage in, and is, for example, an identification number of the work process. “Worker” indicates identification information for identifying a worker W classified into a group and is, for example, an identification number of the worker W. “Video data” indicates moving image data having, captured therein, a work situation of a worker W classified into a group, and is, for example, moving image data captured by a camera worn by the worker W or a camera installed in the plant.

That is, FIG. 7 illustrates an example of data where: for “time T”, data are classified as “worker A”, “video data A”, “worker C”, “video data C”, “worker D”, and “video data D” for a work process identified by “process 1” and data are classified as “worker B” and “video data B” for a work process identified by “process 2”.

### 2-2-4-6. Correspondence Relation Data Storage Unit 14f

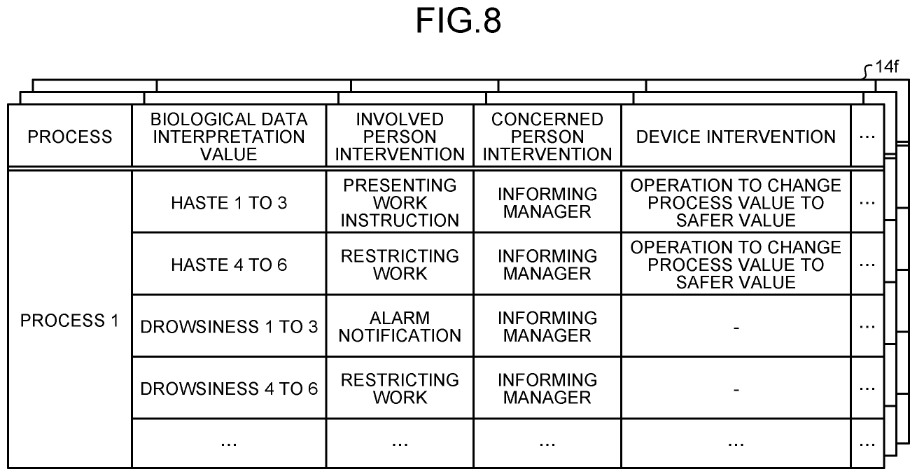

The correspondence relation data storage unit 14f stores correspondence relation data referred to by a decision unit 15d. An example of data stored in the correspondence relation data storage unit 14f will now be described by use of FIG. 8. FIG. 8 is a diagram illustrating an example of the correspondence relation data storage unit 14f in the work support server 10 according to the embodiment. In the example of FIG. 8, the correspondence relation data storage unit 14f has items, such as “process”, “biological data interpretation value”, “involved person intervention”, “concerned person intervention”, and “device intervention”.

“Process” indicates a work process that a worker W engages in, and is, for example, an identification number of the work process. “Biological data interpretation value” indicates a physical or psychological state of a worker W and is expressed by, for example, a characteristic of the state or a numerical value of the state. “Involved person intervention” indicates an intervention means for a worker W1 who is an involved person, in whom abnormality has been detected and is, for example, a notification transmitted to the worker W1 who is the involved person. “Concerned person intervention” indicates an intervention means for a worker W2 other than the involved person, in whom the abnormality has been detected, and is, for example, a notification transmitted to a manager of the worker W1 who is the involved person or to the worker W2 who is engaged in a work process shared with the worker W1 who is the involved person. “Device intervention” indicates an intervention means for a plant device 50 that the worker W1 is concerned with, the worker W1 being the involved person in whom the abnormality has been detected, and is, for example, a means for controlling the plant device 50 being operated by the worker W1 who is the involved person.

That is, FIG. 8 illustrates an example of data, by which, for the work process identified by “process 1”: in a case where the biological data interpretation value is “haste 1 to 3”, an involved person intervention, “presenting work instruction”, a concerned person intervention, “informing manager”, and a device intervention, “operation to change process value to safer value”, are selected; in a case where the biological data interpretation value is “haste 4 to 6”, an involved person intervention, “restricting work”, the concerned person intervention, “informing manager”, and the device intervention, “operation to change process value to safer value”, are selected; in a case where the biological data interpretation value is “drowsiness 1 to 3”, an involved person intervention, “alarm notification”, and the concerned person intervention, “informing manager”, are selected; and in a case where the biological data interpretation value is “drowsiness 4 to 6”, the involved person intervention, “restricting work”, and the concerned person intervention, “informing manager”, are selected.

### 2-2-4-7. Intervention Data Storage Unit 14g

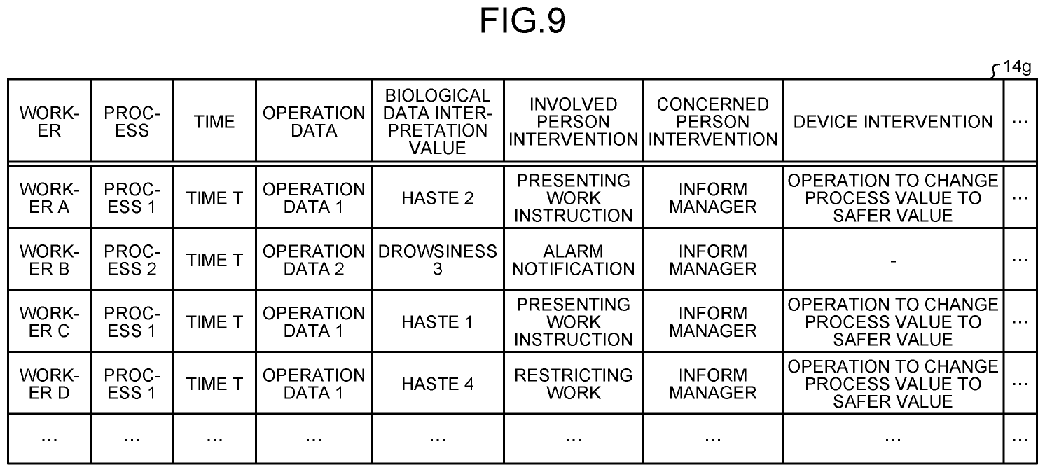

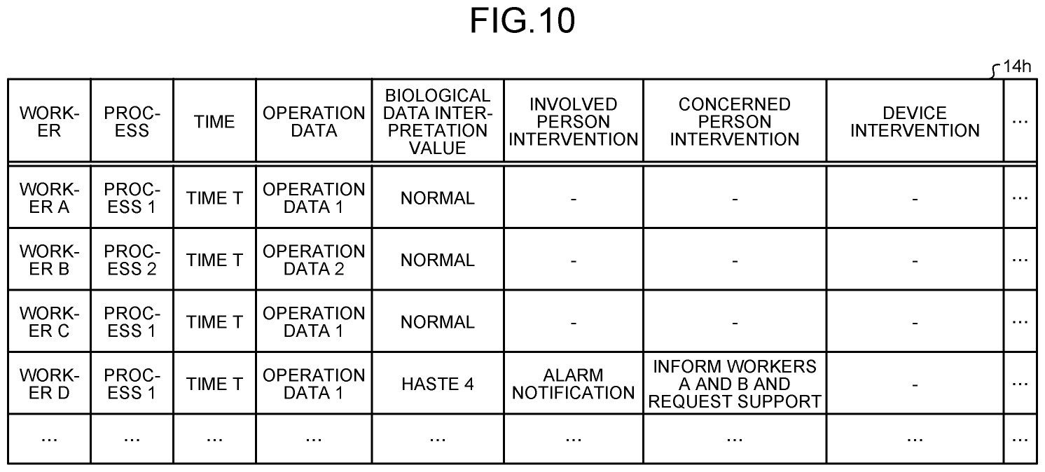

The intervention data storage unit 14g stores intervention data generated by the decision unit 15d. An example of data stored by the intervention data storage unit 14g will now be described by use of FIG. 9 and FIG. 10. FIG. 9 and FIG. 10 are diagrams each illustrating an example of the intervention data storage unit 14g in the work support server 10 according to the embodiment. As illustrated in FIG. 9 and FIG. 10, the intervention data storage unit 14g has items, such as “worker”, “process”, “time”, “operation data”, “biological data interpretation value”, “involved person intervention”, “concerned person intervention”, and “device intervention”.

“Worker” indicates identification information for identifying a worker W, for whom an intervention is to be made and is, for example, an identification number of the worker W. “Process” indicates a work process that a worker W engages in, the worker W being a worker for whom an intervention is to be made, and is, for example, an identification number of the work process. “Time” indicates time when a worker W, for whom an intervention is to be made, engages in work, and is expressed by, for example, the hour and minutes. “Operation data” indicates operation data related to work of a worker W, for whom an intervention is to be made, and is, for example, a measured value from a plant device 50 operated by the worker W. “Biological data interpretation value” indicates an estimated physical or psychological state of a worker W and is expressed by, for example, a characteristic of the state or a numerical value of the state. “Involved person intervention” indicates an intervention means for a worker W1 who is an involved person, in whom abnormality has been detected. and is, for example, a notification to be transmitted to the worker W1 who is the involved person. “Concerned person intervention” indicates an intervention means for a worker W2 other than an involved person, in whom abnormality has been detected, and is, for example, a notification to be transmitted to a manager of a worker W1 who is the involved person or to the worker W2 who is engaged in the same work process as the worker W1 who is the involved person. “Device intervention” indicates an intervention means for a plant device 50 that the worker W1 is concerned with, the worker W1 being the involved person in whom the abnormality has been detected, and “device intervention” is, for example, a control means for the plant device 50 being operated by the worker W1 who is the involved person.

That is, FIG. 9 illustrates an example of data, by which: the involved person intervention, “presenting work instruction”, the concerned person intervention, “informing manager”, and the device intervention, “operation to change process value to safer value”, are decided to be made for the worker WA identified by “worker A” (the process, “process 1”, the time, “time T”, and operation data, “operation data 1”) because the biological data interpretation value is “haste 2”; the involved person intervention, “alarm notification”, and the concerned person intervention, “informing manager”, are decided to be made for the worker WB identified by “worker B” (the process, “process 2”, the time, “time T”, and operation data, “operation data 2”) because the biological data interpretation value is “drowsiness 3”; the involved person intervention, “presenting work instruction”, the concerned person intervention, “informing manager”, and the device intervention, “operation to change process value to safer value”, are decided to be made for the worker WC identified by “worker C” (the process, “process 1”, the time, “time T”, and operation data, “operation data 1”) because the biological data interpretation value is “haste 1”; and the involved person intervention, “restricting work”, the concerned person intervention, “informing manager”, and the device intervention, “operation to change process value to safer value”, are decided to be made for the worker WD identified by “worker D” (the process, “process 1”, the time, “time T”, and operation data, “operation data 1”) because the biological data interpretation value is “haste 4”.

Furthermore, FIG. 10 illustrates an example of data, by which: for the worker WA identified by “worker A” (the process, “process 1”, the time, “time T”, and the operation data, “operation data 1”), no intervention is decided to be made because the biological data interpretation value is “normal”; for the worker WB identified by “worker B” (the process, “process 2”, the time, “time T”, and the operation data, “operation data 2”), no intervention is decided to be made because the biological data interpretation value is “normal”; for the worker WC identified by “worker C” (the process, “process 1”, the time, “time T”, and the operation data, “operation data 1”), no intervention is decided to be made because the biological data interpretation value is “normal”; and for the worker WD identified by “worker D” (the process, “process 1”, the time, “time T”, and the operation data, “operation data 1”), the involved person intervention, “alarm notification” and a concerned person intervention “informing workers A and B and requesting support”, are decided to be made because the biological data interpretation value is “haste 4”.

### 2-2-4-8. Prediction Model 14h

The prediction model 14h is a machine learning model that outputs an evaluation index for the plant in accordance with input of time-series data including biological data, operation data, work environment data, or work data. For example, the prediction model 14h is a deterministic model, such as a physical model, or a statistical model that executes deep learning.

### 2-2-5. Control Unit 15

The control unit 15 governs the overall control of the work support server 10. The control unit 15 has an acquisition unit 15a, the classification unit 15b, an analysis unit 15c, the decision unit 15d, an execution unit 15e, a training unit 15f, a prediction unit 15g, and a display unit 15h. The control unit 15 is implemented by, for example, an electronic circuit, such as a central processing unit (CPU) or a micro processing unit (MPU), or an integrated circuit, such as an application specific integrated circuit (ASIC) or a field programmable gate array (FPGA).

### 2-2-5-1. Acquisition Unit 15a

The acquisition unit 15a acquires biological data on plural workers W who engage in the same work related to operation of the plant. For example, the acquisition unit 15a acquires biological data on pulses, heartbeat, skin electric potential, myoelectric potential, eye electric potential, brain waves, cerebral blood flow, expressions, tones of voice, and blood sugar levels, transmitted from the wearable devices 40 (40A, 40B, 40C, and 40D) worn by the plural workers W (WA, WB, WC, and WD). The acquisition unit 15a stores the biological data acquired, into the biological data storage unit 14c.

In the above described biological data acquisition process, states of the workers W are able to be acquired in real time by acquisition of the biological data on the workers W using one or more of the wearable devices 40. The biological data acquired are processed into representations that are readily interpreted by humans and serve as a basis for judgment for feedback to humans or apparatuses.

Furthermore, the acquisition unit 15a acquires operation data collected from the plant devices 50 installed in the plant. For example, the acquisition unit 15a acquires operation data on pressure of fluid or solid, a flow velocity, a temperature, and/or a liquid level, transmitted from the plural plant devices 50 (50A, 50B, and 50C) installed in a tank, a pipe, and/or a furnace. The acquisition unit 15a stores the operation data acquired, into the operation data storage unit 14d.

Furthermore, the acquisition unit 15a acquires work environment data related to environments in the plant, the environments being where plural workers respectively engage in work. For example, the acquisition unit 15a acquires work environment data on air temperature, humidity, sound, brightness, or odor, in the plant, from the measurement device 20 installed in the plant. Furthermore, the acquisition unit 15a may acquire weather information as work environment data on the outside of the plant. The acquisition unit 15a stores the work environment data acquired, into the work environment data storage unit 14a.

Furthermore, the acquisition unit 15a acquires work data related to work that each of plural workers engages in. For example, the acquisition unit 15a acquires work data on working hours, work locations, operated devices, and video data, for the workers W, the work data having been transmitted from the management device 30 installed in the plant. In a specific example, the acquisition unit 15a acquires work data on work hours, work locations, and operated devices, for workers W from a PC where roster data have been stored, and acquires work data, such as video data, from a camera installed in the plant or cameras worn by the workers W. The acquisition unit 15a stores the work data acquired, into the work data storage unit 14b.

### 2-2-5-2. Classification Unit 15b

The classification unit 15b determines a work process of each of plural workers W by using work environment data and work data and classifies the plural workers W by shared work process. For example, the classification unit 15b determines work processes that the plural workers W (WA, WB, WC, and WD) engage in by time, classifies the plural workers (WA, WB, WC, and WD) by shared work process, and generates group data.

In a specific example, by using data on areas in the plant, work hours, work locations, and operated devices, as well as video data, the classification unit 15b determines that the worker WA, the worker WC, and the worker WD are engaging in a work process, the process 1, and the worker WB is engaging in a work process, the process 2, and generates group data having the workers WA, WB, WC, and WD classified as “process 1: worker WA, worker WC, and worker WD” and “process 2: worker WB”. The classification unit 15b stores the group data generated, into the group data storage unit 14e.

In the above described worker classification process, the classification unit 15b determines the work processes for the workers W on the basis of the work environment data and work data on the workers W, among the data acquired by the acquisition unit 15a. As to a work process determination process, the classification unit 15b is capable of minutely performing update (every few seconds to few minutes). Therefore, the above described worker classification process enables the work to be determined more realistically using, not only the data based on the roster including predetermined schedules of the workers, but also videos from line-of-sight cameras on the workers W, the videos being acquired in real time, and information on targets operated by the workers W, for example.

### 2-2-5-3. Analysis Unit 15c

The analysis unit 15c estimates a state of each of plural workers W on the basis of biological data on the plural workers W and analyzes a state of each of the plural workers W. For example, the analysis unit 15c estimates, on the basis of biological data collected from devices worn respectively by the plural workers W, a physical state or a psychological state as a state of each of the plural workers W, and in a case where the ratio of workers W in a predetermined state to the plural workers W engaging in the same work has exceeded a threshold, the analysis unit 15c detects abnormality in the workers W engaging in the work. Furthermore, the analysis unit 15c analyzes a state of each of the plural workers W who engage in the same work, on the basis of a result of classification by the classification unit 15b.

As to a specific example of states to be estimated, the analysis unit 15c analyzes biological data acquired by the acquisition unit 15a by event-related potential analysis, frequency analysis, waveform analysis, or using a machine learning analysis technique, such as deep learning, and executes characterization or classification of states of the workers W. The analysis unit 15c estimates a characteristic, such as “normal”, “hasty”, and “drowsy”, as a physical state or a psychological state of each worker W and estimates a numerical value indicating the degree of the state.

In the above described data analysis process, the analysis unit 15c turns unprocessed biological data acquired, into a state usable as a basis for judgment, by processing the biological data into a form that is able to be interpreted by humans.

As to a specific example of abnormality detected, in a case where, for example, 80% or more of the worker WA, worker WC, and worker WD engaging in work of the process 1 that is a work process is presumed to be in a “hasty” state, the analysis unit 15c detects abnormality in the workers W engaging in the process 1. In a case where the analysis unit 15c presumes that all of the workers W are in the “hasty” state (the AND condition is met), the analysis unit 15c may detect abnormality in the workers W engaging in the process 1 and immediately start making an intervention in the abnormality. On the contrary, in a case where the analysis unit 15c presumes that only some of the workers W are in the “hasty” state (the AND condition is not met), the analysis unit 15c may make an intervention after checking the situation without detecting abnormality in the workers W engaging in the process 1.

### First Specific Example

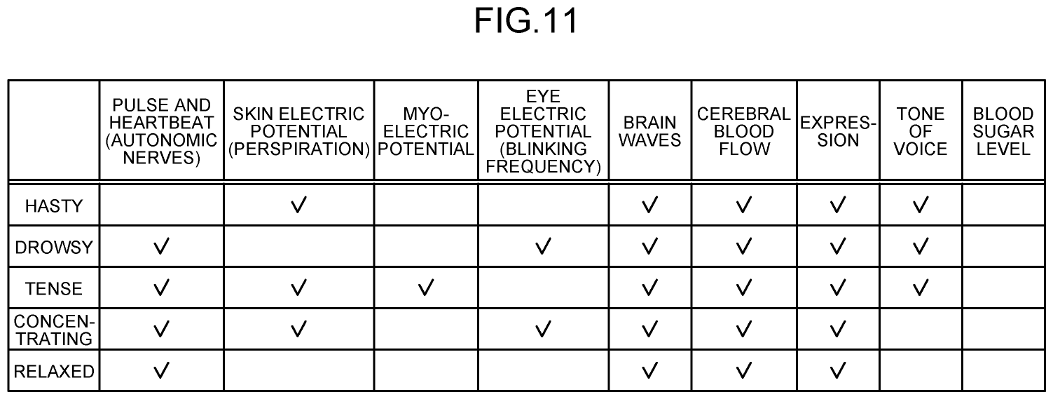

A first specific example of a state estimation process executed by the analysis unit 15c will now be described by use of FIG. 11. FIG. 11 is a diagram illustrating the first specific example of the state estimation process according to the embodiment. The process in the first specific example is just an example of the state estimation process and is not particularly limited.

As illustrated by the example in FIG. 11, in the first specific example of the state estimation process, by using biological data, such as “pulse and heartbeat (autonomic nerves)”, “skin electric potential (perspiration) “, “myoelectric potential”, “eye electric potential (blinking frequency)”, “brain waves”, “cerebral blood flow”, “expression”, “tone of voice”, and “blood sugar level”, the analysis unit 15c executes two-level rating (with a check: applicable, without a check: not applicable) of applicability and inapplicability of each piece of biological data, and thereby estimates, as a physical state or psychological state of a worker W, a characteristic, such as “hasty”, “drowsy”, “tense”, “concentrating”, or “relaxed (normal)”.

As illustrated by the example in FIG. 11, the analysis unit 15c presumes that a state of a worker W is “hasty” in a case where biological data on the worker W exceed predetermined thresholds, the biological data being “skin electric potential (perspiration)”, “brain waves”, “cerebral blood flow”, “expression”, and “tone of voice”. Furthermore, the analysis unit 15c presumes that a state of a worker W is “drowsy” in a case where pieces of biological data on the worker W respectively exceed their predetermined thresholds, the pieces of biological data being “pulse and heartbeat (autonomic nerves)”, “eye electric potential (blinking frequency)”, “brain waves”, “cerebral blood flow”, “expression”, and “tone of voice”. Furthermore, the analysis unit 15c presumes that a state of a worker W is “tense” in a case where pieces of biological data on the worker W respectively exceed their predetermined thresholds, the pieces of biological data being “pulse and heartbeat (autonomic nerves)”, “skin electric potential (perspiration)”, “myoelectric potential”, “brain waves”, “cerebral blood flow”, “expression”, and “tone of voice”. Furthermore, the analysis unit 15c presumes that a state of a worker W is “concentrating” in a case where pieces of biological data on the worker W respectively exceed their predetermined thresholds, the pieces of biological data being “pulse and heartbeat (autonomic nerves)”, “skin electric potential (perspiration)”, “eye electric potential (blinking frequency)”, “brain waves”, “cerebral blood flow”, and “expression”. Furthermore, the analysis unit 15c presumes that a state of a worker W is “relaxed” in a case where pieces of biological data on the worker W respectively exceed their predetermined thresholds, the pieces of biological data being “pulse and heartbeat (autonomic nerves)”, “brain waves”, “cerebral blood flow”, and “expression”.

The analysis unit 15c may estimate a numerical value indicating the degree of the state, on the basis of numerical values exceeding the thresholds for the pieces of biological data. For example, the analysis unit 15c estimates the state and the degree for a worker W to be “haste 4” in a case where pieces of biological data on the worker W exceed their thresholds, the pieces of biological data being “skin electric potential (perspiration)”, “brain waves”, “cerebral blood flow”, “expression”, and “tone of voice”, and all of the numerical values exceeding the thresholds for the pieces of biological data are equal to or larger than set values that have been set for the respective pieces of biological data.

### Second Specific Example

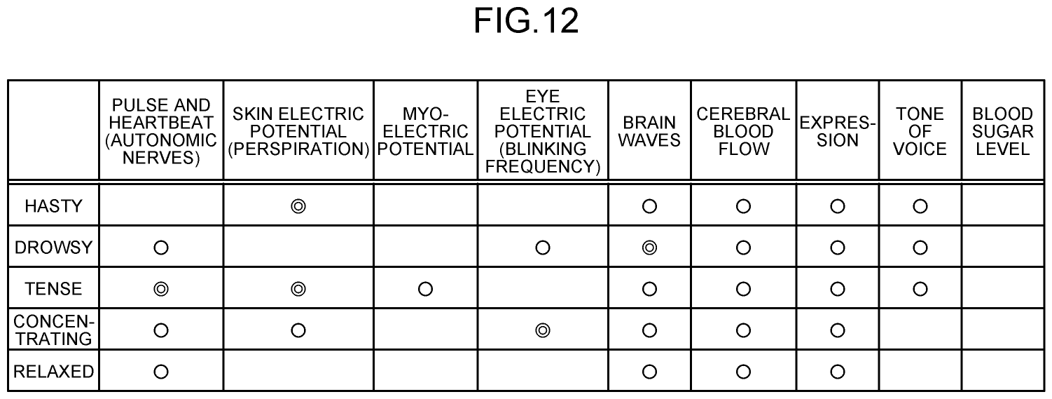

A second specific example of the state estimation process executed by the analysis unit 15c will now be described by use of FIG. 12. FIG. 12 is a diagram illustrating the second specific example of the state estimation process according to the embodiment. The process in the second specific example is just an example of the state estimation process and is not particularly limited.

As illustrated by the example in FIG. 12, in the second specific example of the state estimation process, by using biological data, such as “pulse and heartbeat (autonomic nerves)”, “skin electric potential (perspiration)”, “myoelectric potential”, “eye electric potential (blinking frequency)”, “brain waves”, “cerebral blood flow”, “expression”, “tone of voice”, and “blood sugar level”, the analysis unit 15c executes three-level rating of applicability of two levels and inapplicability (double circle: notably applicable; circle: applicable; without mark: inapplicable) of each piece of the biological data, and thereby estimates, as a physical state or psychological state of the worker W, a characteristic, such as “hasty”, “drowsy”, “tense”, “concentrating”, or “relaxed (normal)”.

As illustrated by the example in FIG. 12, in a case where pieces of biological data on a worker W exceed their predetermined thresholds, the pieces of biological data being “skin electric potential (perspiration)” (double circle), “brain waves” (circle), “cerebral blood flow” (circle), “expression” (circle), and “tone of voice” (circle), the analysis unit 15c presumes that a state of the worker W is “hasty”. Furthermore, in a case where pieces of biological data on a worker W respectively exceed their predetermined thresholds, the pieces of biological data being “skin electric potential (perspiration)” (circle), “eye electric potential (blinking frequency)” (circle), “brain waves” (double circle), “cerebral blood flow” (circle), “expression” (circle), and “tone of voice” (circle), the analysis unit 15c presumes that a state of the worker W is “drowsy”. Furthermore, in a case where pieces of biological data on a worker W respectively exceed their predetermined thresholds, the pieces of biological data being “pulse and heartbeat (autonomic nerves)” (double circle), “skin electric potential (perspiration)” (double circle), “myoelectric potential” (circle), “brain waves” (circle), “cerebral blood flow” (circle), “expression” (circle), and “tone of voice” (circle), the analysis unit 15c presumes that a state of the worker W is “tense”. Furthermore, in a case where pieces of biological data on a worker W respectively exceed their predetermined thresholds, the pieces of biological data being “pulse and heartbeat (autonomic nerves)” (circle), “skin electric potential (perspiration)” (circle), “eye electric potential (blinking frequency)” (double circle), “brain waves” (circle), “cerebral blood flow” (circle), and “expression” (circle), the analysis unit 15c presumes that a state of the worker W is “concentrating”. Furthermore, in a case where pieces of biological data on a worker W respectively exceed their predetermined thresholds, the pieces of biological data being “pulse and heartbeat (autonomic nerves)” (circle), “brain waves” (circle), “cerebral blood flow” (circle), and “expression” (circle), the analysis unit 15c presumes that a state of the worker W is “relaxed”.

The analysis unit 15c may determine whether each piece of biological data is “notably applicable (double circle)” or “applicable (circle)” on the basis of a numerical value exceeding the threshold for the piece of biological data and estimate a numerical value indicating a degree of the state on the basis of the number of double circles. For example, in a case where pieces of biological data on a worker W exceed their predetermined thresholds, the pieces of biological data being “pulse and heartbeat (autonomic nerves)”, “eye electric potential (blinking frequency)”, “brain waves”, “cerebral blood flow”, “expression”, and “tone of voice”, and the number of pieces of biological data determined to be “notably applicable (double circle)” is one, the analysis unit 15c estimates the state and the degree of the worker W to be “drowsiness 2”.

### 2-2-5-4. Decision Unit 15d

The decision unit 15d determines whether or not an intervention in shared work by the work support server 10 that is a work support apparatus is necessary, on the basis of a result of analysis by the analysis unit 15c. For example, the decision unit 15d determines an intervention means for the plant in a case where abnormality in a worker W engaging in work has been detected by the analysis unit 15c. Furthermore, the decision unit 15d determines an intervention means by referring to correspondence relation data indicating a history of intervention in the plant, through use of a state of each of plural workers W, operation data, work environment data, and work data. The decision unit 15d stores intervention data on the determined intervention means, into the intervention data storage unit 14g.

The correspondence relation data referred to in the above described intervention determination process are data stored in a tabular format, for example, the data being on intervention means expected to prevent worsening of the operation state of the plant or cause the situation to transition to a more optimum situation, the data being stored correspondingly to states determined by biological data interpretation results (states of workers W) for workers W included in each group generated by the classification unit 15b, work environment data, work data, and operation data on the plant. The correspondence relations may be stored beforehand, or may be input or set by, for example, an administrator each time, on the basis of data acquired by the acquisition unit 15a in the past or past intervention results. That is, the above described intervention determination process using the correspondence relation data enables selection of an intervention plan determined to be appropriate on the basis of experience and actual results, in accordance with biological data interpretation results and operation data.

### First Specific Example

In a first specific example, the decision unit 15d refers to the correspondence relation data illustrated in FIG. 8, determines the involved person intervention, “presenting work instruction”, the concerned person intervention, “informing manager”, and the device intervention, “operation to change process value to safer value”, as intervention means for the worker WA presumed to correspond to “haste 2”, determines the involved person intervention, “alarm notification”, and the concerned person intervention, “informing manager”, as intervention means for the worker WB presumed to correspond to “drowsiness 3”, determines the involved person intervention, “presenting work instruction, the concerned person intervention, “informing manager”, and the device intervention “operation to change process value to safer value”, as intervention means for the worker WC presumed to correspond to “haste 1”, and determines the involved person intervention, “restricting work”, the concerned person intervention, “contacting manager”, and the device intervention, “operation to change process value to safer value”, as intervention means for the worker WD presumed to correspond to “haste 4”, and thereby generates the intervention data illustrated in FIG. 9.

In this first specific example, because the worker WA, the worker WC, and the worker WD engaging in the process 1 that is a work process shared by them are all in hasty states, the decision unit 15d determines that the workers W are likely to be confronting some sort of abnormality and are thus in the hasty states and determines intervention means to be implemented for the involved people, the concerned person, and the devices. Examples of the concerned person herein include the manager for the work of a worker W1 presumed to be in the state and a worker W2 concerned with the work of the worker W1.

### Second Specific Example

In a second specific example, even if the decision unit 15d has referred to correspondence relation data and presumed a state of the worker WD to be “haste 4”, in a case where states of the worker WA and worker WC for the process 1 that is a shared work process are “normal”, the decision unit 15d determines, as intervention means for the worker WD, the involved person intervention, “alarm notification”, and the concerned person intervention, “informing workers A and B and requesting support”, and thereby generates the intervention data illustrated in FIG. 10.

In this second specific example, because only the worker WD, among the worker WA, the worker WC, and the worker WD who are engaging in the process 1 that is a work process shared by these workers, is in a hasty state, there is a possibility of abnormality occurring only in work of the worker WD or a possibility of a false positive where the hasty state is being erroneously detected for the worker WD, and the decision unit 15d thus determines an intervention means of requesting the worker WA and the worker WC performing the same process 1 for support, such as, check of the work and state of the worker WD.

In the above described first and second specific examples of the intervention determination process, by checking biological data interpretation results for a worker group, work, operation data on the plant, and a work environment, against correspondence relation data, in accordance with each of groups generated by the classification unit 15b, the decision unit 15d determines intervention means that are expected to cause the situation to transition to a more optimum situation to prevent worsening of the situation, the intervention means being for the individual workers W included in the group, all of the workers W included in the group, one or more workers W concerned with the work, a manager of the work, the devices and apparatuses controlled in the work, and/or other apparatuses. The decision unit 15d changes the extent of the above described interventions for the workers W, manager, apparatuses, and devices, in accordance with the degree of agreement among the biological data interpretation results for the plural workers W engaging in work regarded as the same work.

That is, in the above described first specific example of the intervention determination process, in a case where the degree of agreement among the biological data interpretation results for a worker group is high, a possibility that the workers W included in the worker group and performing the same process are in the states based on the biological data interpretation results is determined to be high, and a more effective intervention can be expected to be made on the basis of accurate information related to the state of the workers W. For example, if plural workers W engaging in specific work are equally found to be in a state deviating from a normal state, a situation where abnormality has occurred in the work and the workers W are struggling with the abnormality can be supposed. In this case, the situation is considered to be higher in urgency and importance, and a prioritized notification to a superior manager is desirably made, or an intervention to cause the apparatuses and devices involved in the work to transition to safer states is desirably made without waiting for the manager's judgment in some operation states at the time.

By contrast, in the second specific example of the intervention determination process, in a case where the degree of agreement among the biological data interpretation results for a worker group is low, there may be a possibility that abnormality has occurred only in the work of a specific worker W1 engaging in the process or the state of the specific worker W1 has been erroneously determined (a false positive). In this case, a preventive intervention, such as giving feedback for alleviating the abnormal state to the worker W1 by sound or requesting another worker W2 engaging in the same process as the worker W1 to check and support the work, can be made at low cost, the preventive intervention being unlikely to invite an irreversible situation.

That is, interventions are expected to entail some cost (for example, an intervention of stopping part of factory or plant functions to prevent an accident results in opportunity loss of being unable to produce what could have been produced originally), but in the above described intervention determination process, a low-cost intervention is able to be made instead of a high-cost intervention. In addition, the above described intervention determination process enables improvement of the precision of the judgment to make a high-cost intervention.

### First Intervention Determination Process

The decision unit 15d determines an intervention means by using time evolution of an evaluation index for the plant, the time evolution having been predicted by the prediction unit 15g, from among plural intervention means selected by reference to correspondence relation data. For example, in a case where a state of a worker W has been presumed to be “hasty”, by referring to correspondence relation data, the decision unit 15d selects plural intervention means, predicts time evolution of an evaluation index for the plant for when the selected intervention means are implemented, and determines, as an intervention means for the worker W, “presenting work instruction”, for which the most preferable prediction result is obtained. In a specific example, the decision unit 15d determines an intervention means with the largest process value after elapse of a predetermined time period or an intervention means with the smallest amount of reduction in a process value after elapse of a predetermined time period, from among the plural intervention means selected.

### Second Intervention Determination Process

The decision unit 15d determines an intervention means on the basis of a history of intervention based on time evolution of an evaluation index predicted by the prediction unit 15g, the history being among plural histories of intervention included in correspondence relation data. For example, the decision unit 15d predicts time evolution of an evaluation index for the plant for when all of the intervention means stored in the correspondence relation data are implemented, extracts correspondence relation data including plural intervention means, for which preferred prediction results are obtained, the preferred prediction results having values equal to or larger than a predetermined value, and determines an intervention means for the worker W from the extracted correspondence relation data. In a specific example, the decision unit 15d predicts a process value corresponding to a time after elapse of a predetermined time period for when all of the intervention means stored in the correspondence relation data are implemented, extracts correspondence relation data including plural intervention means, for which process values equal to or larger than a predetermined value are obtained, and determines an intervention means for the worker W from the extracted correspondence relation data.

The above described first intervention determination process and second intervention determination process are each a process of giving only feedback resulting in desired progress by using a simulation model, a digital twin. That is, the above described first intervention determination process and second intervention determination process enable selection of an effective intervention by: simulating any change over time in the operation state of the plant, the change being caused by an intervention made in an apparatus or device, the intervention being presented by the decision unit 15d; and not making the intervention in a case where the intervention does not lead to a desirable result.

### Third Intervention Determination Process

The decision unit 15d determines an intervention means that has been specified, from among plural intervention means selected by reference to correspondence relation data. For example, in a case where plural intervention means are presented as being selectable by reference to correspondence relation data, the decision unit 15d determines, from among the plural intervention means presented, an intervention means for a worker W by receiving designation by a manager of the plant.

The above described third intervention determination process is a process of receiving, as input, a judgment by the manager of the plant, for example, for the determination by the decision unit 15d and giving feedback via the judgment. In the above described third intervention determination process, a judging person's judgment on an intervention presented by the decision unit 15d enables execution of only an effective intervention without execution of an intervention not leading to a desired result. The above described third intervention determination process is applicable to: a case where the operation state is desirably monitored thoroughly, such as a case where the plant has a short track record of operation or a case where there is a worker without much work experience; or a case where data have not been accumulated sufficiently to make a simulation, create a digital twin, or generate correspondence relation data.

### 2-2-5-5. Execution Unit 15e

The execution unit 15e executes intervention for the plant where shared work is performed. For example, the execution unit 15e executes intervention for the plant, on the basis of an intervention means determined by the decision unit 15d. Furthermore, the execution unit 15e executes notification to a predetermined worker or a person concerned with the predetermined worker, or control of a plant device, according to the intervention means determined.

In a specific example, in a case where the involved person intervention, “presenting work instruction”, for a worker W1 has been determined by the decision unit 15d, the execution unit 15e notifies a wearable device 40 worn by the worker W1 of an operation instruction based on a manual for abnormality, through a message, “please execute XYZ operation”. Furthermore, in a case where the involved person intervention, “informing manager”, for a person concerned with the work of the worker W1 has been determined by the decision unit 15d, the execution unit 15e notifies a terminal apparatus of a manager of the worker W1 of the occurrence of abnormality, through a message, “abnormality has been detected in process 1”.

### 2-2-5-6. Training Unit 15f

The training unit 15f trains a machine learning model that outputs an evaluation index for the plant in accordance with input of time-series data including biological data, operation data, work environment data, or work data. For example, the training unit 15f constructs the prediction model 14h by using time-series data holding chronological relations for biological data, operation data, work environment data, and work data on plural workers W in the plant. In a specific example, the training unit 15f constructs the prediction model 14h for digital twins, by using the time-series data as training data for selection of a time evolution equation and parameters of a deterministic model (such as a physical model) or for generation of a statistical model (such as a deep learning model).

### 2-2-5-7. Prediction Unit 15g

The prediction unit 15g predicts time evolution of an evaluation index from a time point of execution of intervention, on the basis of a result obtained by input of biological data, operation data, work environment data, or work data changed by the execution of the intervention into a machine learning model that has been trained. For example, by inputting, into the prediction model 14h that outputs a key performance indicator (KPI), such as a process value related to operation of the plant, biological data, operation data, work environment data, or work data changed by execution of intervention, the prediction unit 15g predicts time evolution of the KPI from a time point of perturbation (the intervention) made in a predetermined initial state.

### 2-2-5-8. Display Unit 15h

The display unit 15h displays group data generated by the classification unit 15b. For example, the display unit 15h displays a work situation, such as video data on workers W for each work process classified by the classification unit 15b, on a terminal apparatus of a manager of the plant.

### Specific Example of Display Screen

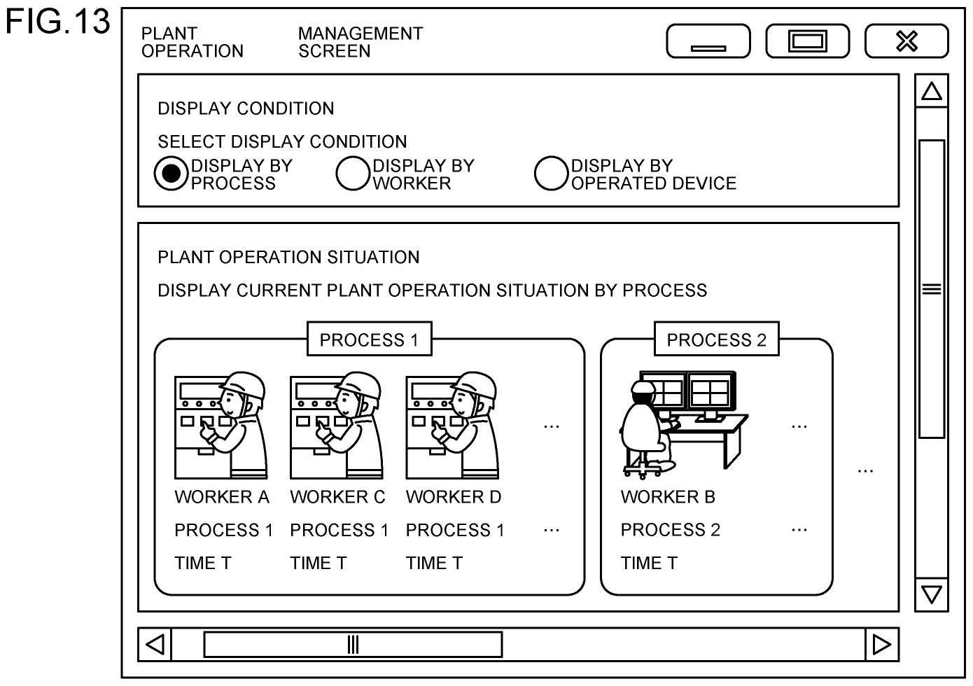

A specific example of a display screen output by the display unit 15h will now be described by use of FIG. 13. FIG. 13 is a diagram illustrating a specific example of a display screen according to the embodiment. As illustrated in FIG. 13, the display unit 15h refers to group data generated by the classification unit 15b and displays an operation situation of the plant, in accordance with a display condition selected. For example, the display unit 15h is capable of displaying radio buttons allowing “display by process”, “display by worker”, or “display by operated device”, to be selected as a display condition.

In the example of FIG. 13, the display unit 15h displays, as “plant operation situation”, video data on “worker A”, “worker C”, and “worker D” engaging in the work process, “process 1”, as well as video data on “worker B” engaging in the work process, “process 2”.

The above described group data display process enables workers W engaging in each kind of work to be known in real time by grouping all of workers in the plant into groups of workers W, each of the groups of workers W engaging in work regarded as the same (including work where individual devices operated by the workers W are different from one another but the workers W are considered to have the same object in their higher layer). Furthermore, enabling the work to be displayed: allows a manager of the work or the worker W2 engaging in related work to immediately view the worker W1 currently involved in the specific work; and is thus expected to facilitate recognition of the situation of the plant operation. Displaying states of workers W engaging in each kind of work is also expected to enable the states of the workers W involved in the plant operation to be readily known. For example, if a state of a specific worker W1 engaging in specific work is undesirable in terms of execution of work, the state is readily recognized by another worker W2 and action, such as check of the actual situation or provision of support, is expected to be promoted.

### 2-3. Example of Configuration of Measurement Device 20

An example of a configuration of the measurement device 20 will now be described by use of FIG. 2. For example, the measurement device 20 is a device, such as a thermometer, a hygrometer, a noise meter, a photometer, or an odor measurer, which is installed in the plant, and collects work environment data on, for example, air temperature, humidity, sound, brightness, or odor in the plant. Furthermore, the measurement device 20 is capable of collecting, as work environment data on the outside of the plant, weather information, for example.

### 2-4. Example of Configuration of Management Device 30

An example of a configuration of the management device 30 will now be described by use of FIG. 2. For example, the management device 30 is a PC or a camera installed in the plant and collects work data on work hours, work locations, operated devices, and video data of workers W.

### 2-5. Example of Configuration of Wearable Device 40

An example of a configuration of the wearable devices 40 will now be described by use of FIG. 2. For example, the wearable devices 40 may each be a wearable earphone electroencephalograph, a heart rate monitor using an electrode, such as a disposable electrode, a wearable electrode, or a belt electrode, a smartwatch, or smart glasses, and collect biological data on pulses, heartbeat, skin electric potential, myoelectric potential, eye electric potential, brain waves, cerebral blood flow, expressions, tones of voice, and blood sugar levels of the workers W.

### 2-6. Example of Configuration of Plant Device 50

An example of a configuration of the plant devices 50 will now be described by use of FIG. 2. For example, the plant devices 50 are sensor devices that are measurement devices installed in tanks, pipes, and furnaces of the plant and collect operation data on pressure of fluid or solid, flow velocities, temperatures, and liquid levels.

### 3. Flow of Process by Work Support System 100

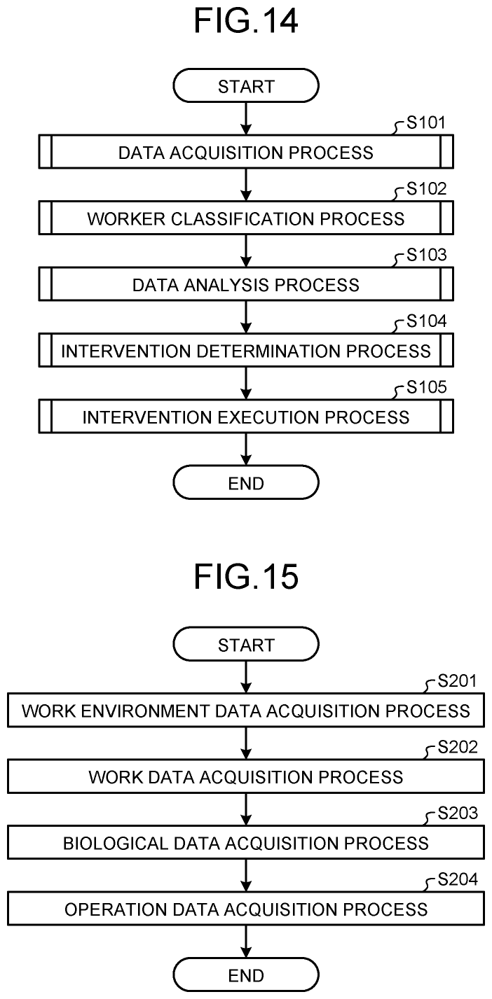

Flows of processes in the work support system 100 according to the embodiment will now be described by use of FIG. 14 to FIG. 19. An overall flow of a process performed by the work support system 100 will hereinafter be described before description of a flow of each process.

### 3-1. Overall Flow of Process by Work Support System 100

The overall flow of the process performed by the work support system 100 will now be described by use of FIG. 14. FIG. 14 is a flowchart illustrating an example of the overall flow of the process according to the embodiment. Steps S101 to S105 described below may be executed in a different sequence. Furthermore, some of processes at Steps S101 to S105 described below may be omitted. Firstly, the acquisition unit 15a of the work support server 10 executes a data acquisition process (Step S101). Secondly, the classification unit 15b of the work support server 10 executes a worker classification process (Step S102). Thirdly, the analysis unit 15c of the work support server 10 executes a data analysis process (Step S103). Fourthly, the decision unit 15d of the work support server 10 executes an intervention determination process (Step S104). Fifthly, the execution unit 15e of the work support server 10 executes an intervention execution process (Step S105) and ends the process.

### 3-2. Flow of Data Acquisition Process

A flow of the data acquisition process by the acquisition unit 15a will now be described by use of FIG. 15. FIG. 15 is a flowchart illustrating an example of the flow of the data acquisition process according to the embodiment. Steps S201 to S204 described below may be executed in a different sequence. Furthermore, some of processes at Steps S201 to S204 described below may be omitted.

### 3-2-1. Work Environment Data Acquisition Process

The acquisition unit 15a executes a work environment data acquisition process (Step S201). For example, the acquisition unit 15a acquires work environment data on air temperature, humidity, sound, brightness, or odor in the plant, the work environment data having been transmitted from the measurement device 20 installed in the plant.

### 3-2-2. Work Data Acquisition Process

The acquisition unit 15a executes a work data acquisition process (Step S202). For example, the acquisition unit 15a acquires work data on work hours, work locations, operated devices, and video data of the workers W, the work data having been transmitted from the management device 30 installed in the plant.

### 3-2-3. Biological Data Acquisition Process

The acquisition unit 15a executes a biological data acquisition process (Step S203). For example, the acquisition unit 15a acquires biological data on pulses, heartbeat, skin electric potential, myoelectric potential, eye electric potential, brain waves, cerebral blood flow, expressions, tones of voice, and blood sugar levels transmitted from the wearable devices 40 (40A, 40B, 40C, and 40D) worn by the plural workers W (WA, WB, WC, and WD).

### 3-2-4. Operation Data Acquisition Process

The acquisition unit 15a executes an operation data acquisition process (Step S204). For example, the acquisition unit 15a acquires operation data on pressure of fluid or solid, flow velocities, temperatures, and liquid levels, transmitted from the plural plant devices (50A, 50B, and 50C) installed in the tanks, pipes, and furnaces.

### 3-3. Flow of Worker Classification Process

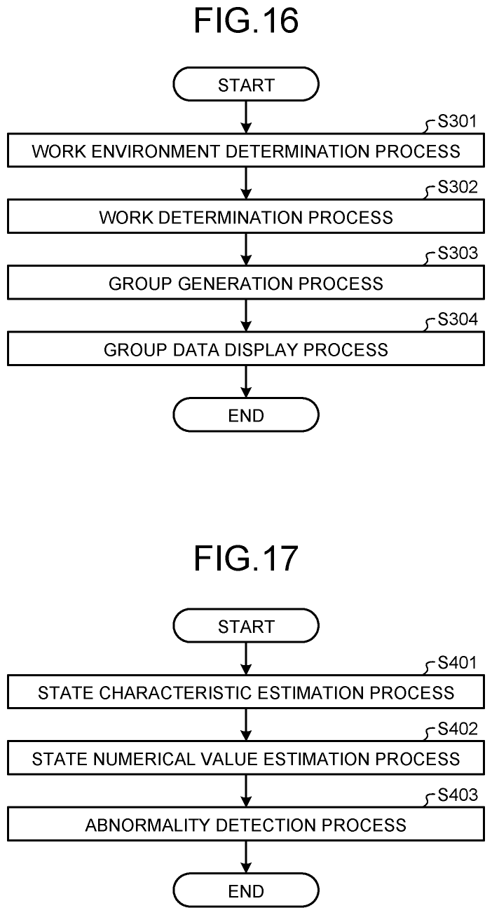

A flow of the worker classification process by the classification unit 15b will now be described by use of FIG. 16. FIG. 16 is a flowchart illustrating an example of the flow of the worker classification process according to the embodiment. Steps S301 to S304 described below may be executed in a different sequence. Furthermore, some of processes at Steps S301 to S304 described below may be omitted.

### 3-3-1. Work Environment Determination Process

The classification unit 15b executes a work environment determination process (Step S301). For example, the classification unit 15b determines a work environment of each worker W by using work environment data.

### 3-3-2. Work Determination Process

The classification unit 15b executes a work determination process (Step S302). For example, the classification unit 15b determines work of each worker W by using work data.

### 3-3-3. Group Generation Process

The classification unit 15b executes a group generation process (Step S303). For example, the classification unit 15b generates group data by classifying workers W by shared work process on the basis of a work environment and work that have been determined for each of the workers W.

### 3-3-4. Group Data Display Process

The display unit 15h executes a group data display process (Step S304). For example, the display unit 15h displays group data generated, on a terminal apparatus of a manager of the plant.

### 3-4. Flow of Data Analysis Process

By use of FIG. 17, a flow of the data analysis process by the analysis unit 15c will now be described by use of FIG. 17. FIG. 17 is a flowchart illustrating an example of the flow of the data analysis process according to the embodiment. Steps S401 to S403 described below may be executed in a different sequence. Furthermore, some of processes at Steps S401 to S403 described below may be omitted.

### 3-4-1. State Characteristic Estimation Process

The analysis unit 15c executes a state characteristic estimation process (Step S401). For example, the analysis unit 15c estimates a characteristic of a state as being “normal”, “hasty”, or “drowsy”.

### 3-4-2. State Numerical Value Estimation Process

The analysis unit 15c executes a state numerical value estimation process (Step S402). For example, the analysis unit 15c estimates a numerical value representing a degree of a characteristic of a state, as “haste 2” or “drowsiness 4”.

### 3-4-3. Abnormality Detection Process

The analysis unit 15c executes an abnormality detection process (Step S403). For example, in a case where the analysis unit 15c has estimated states of all of workers W engaging in the same work process to be “hasty”, the analysis unit 15c detects abnormality in the work process.

### 3-5. Flow of Intervention Determination Process

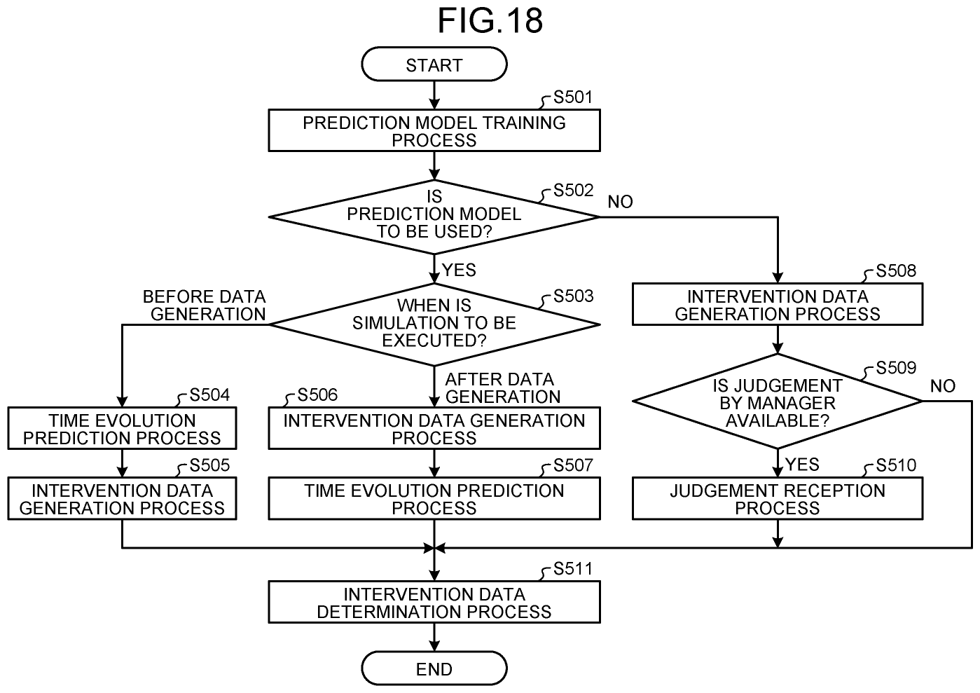

A flow of the intervention determination Process by the decision unit 15d will now be described by use of FIG. 18. FIG. 18 is a flowchart illustrating an example of the flow of the intervention determination process according to the embodiment. Steps S501 to S511 described below may be executed in a different sequence. Furthermore, some of processes at Steps S501 to S511 described below may be omitted.

### 3-5-1. Prediction Model Training Process

The training unit 15f executes a prediction model training process (Step S501). For example, the training unit 15f trains the prediction model 14h that outputs an evaluation index for the plant in response to input of time-series data including biological data, operation data, work environment data, or work data.

### 3-5-2. First Intervention Determination Process

The decision unit 15d executes a first intervention determination process through the following flow. The first intervention determination process is a process using the prediction model 14h and is a process of generating intervention data after a simulation.

### 3-5-2-1. Time Evolution Prediction Process

In a case where the prediction model 14h is to be used (Step S502: Yes) and a simulation is to be executed before data generation (Step S503: before data generation), the decision unit 15d executes a time evolution prediction process (Step S504). For example, the decision unit 15d predicts process values for cases where all of intervention means in correspondence relation data are implemented, and extracts any intervention means, for which the predicted process value is equal to or larger than a predetermined value.

### 3-5-2-2. Intervention Data Generation Process

The decision unit 15d executes an intervention data generation process (Step S505). For example, the decision unit 15d generates intervention data from any intervention means extracted in the process at Step S504, the intervention means being a means for which the predicted process value is equal to or larger than the predetermined value.

### 3-5-3. Second Intervention Determination Process

The decision unit 15d executes a second intervention determination process through the following flow. The second intervention determination process is a process using the prediction model 14h and a process of making a simulation after generating intervention data.

### 3-5-3-1. Intervention Data Generation Process

In a case where the prediction model 14h is to be used (Step S502: Yes) and a simulation is to be executed after data generation (Step S503: after data generation), the decision unit 15d executes an intervention data generation process (Step S506). For example, the decision unit 15d refers to correspondence relation data and generates intervention data including plural intervention means.

### 3-5-3-2. Time Evolution Prediction Process

The decision unit 15d executes a time evolution prediction process (Step S507). For example, the decision unit 15d predicts process values for cases where the intervention means in the intervention data generated in the process at Step S506 are implemented, and selects an optimum intervention means, for which the largest process value is predicted.

### 3-5-4. Third Intervention Determination Process

The decision unit 15d executes a third intervention determination process through the following flow. The third intervention determination process is a process not using the prediction model 14h and a process of receiving a judgment made by a manager.

### 3-5-4-1. Intervention Data Generation Process

In a case where the prediction model 14h is not to be used (Step S502: No), the decision unit 15d executes an intervention data generation process (Step S508). For example, the decision unit 15d refers to correspondence relation data and generates intervention data including plural intervention means.

### 3-5-4-2. Judgment Reception Process

In a case where a judgment made by a manager of the plant is available (Step S509: Yes), the decision unit 15d executes a judgment reception process (Step S510). For example, the decision unit 15d refers to the correspondence relation data and receives an intervention means specified by the manager of the plant, from the intervention data including the plural intervention means.

### 3-5-5. Fourth Intervention Determination Process

The decision unit 15d executes a fourth intervention determination process through the following flow. The fourth intervention determination process is a process not using the prediction model 14h and a process of not receiving a judgment made by a manager.

### 3-5-5-1. Intervention Data Generation Process

In a case where the prediction model 14h is not to be used (Step S502: No), the decision unit 15d executes an intervention data generation process (Step S508). For example, the decision unit 15d refers to correspondence relation data and generates intervention data including plural intervention means. Furthermore, in a case where a judgment made by a manager of the plant is not available (Step S509: No), the decision unit 15d proceeds to a process of Step S511.

### 3-5-6. Intervention Data Determination Process

After the process of Step S505, S507, S509, or S510 has ended, the decision unit 15d executes an intervention data determination process (Step S511). For example, the decision unit 15d determines intervention data satisfying a condition, from among the intervention data generated.

### 3-5-7. Others

The decision unit 15d may execute the third intervention determination process after executing the first intervention determination process or second intervention determination process. That is, the decision unit 15d may implement only an intervention means approved in response to reception of a judgment made by a manager, the intervention means being from intervention data generated via a process using the prediction model 14h.

### 3-6. Flow of Intervention Execution Process

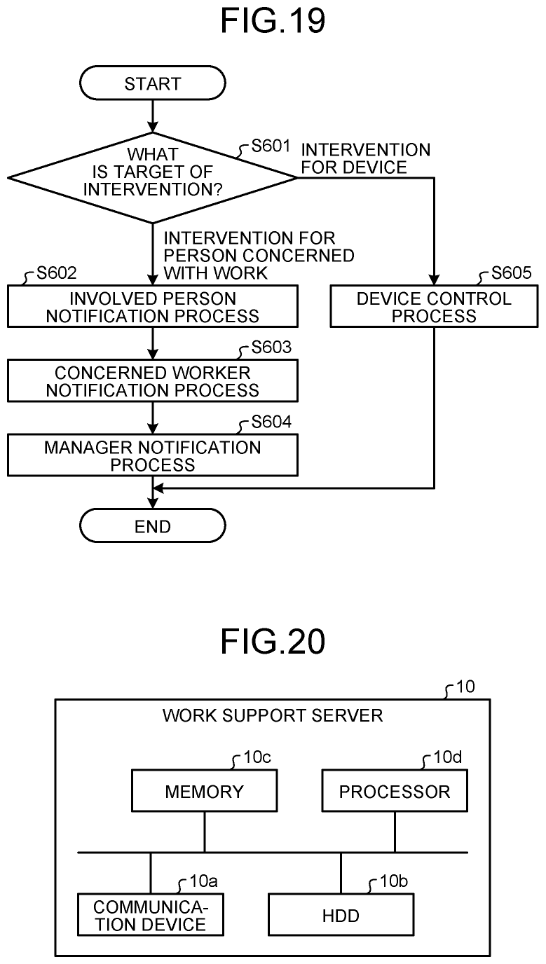

A flow of the intervention execution process by the execution unit 15e will now be described by use of FIG. 19. FIG. 19 is a flowchart illustrating an example of the flow of the intervention execution process according to the embodiment. Steps S601 to S605 described below may be executed in a different sequence. Furthermore, some of processes at Steps S601 to s605 described below may be omitted.

### 3-6-1. First Intervention Execution Process

The execution unit 15e executes a first intervention execution process through the following flow. The first intervention determination process is a process having, as a target of intervention, a person concerned with work.

### 3-6-1-1. Involved Person Notification Process

In a case where a target of intervention is a person concerned with work (Step S601: intervention for person concerned with work), the execution unit 15e executes an involved person notification process (Step S602). For example, the execution unit 15e transmits an alarm notification to a worker W1, in whom abnormality has been detected.

### 3-6-1-2. Concerned Worker Notification Process

The execution unit 15e executes a concerned worker notification process (Step S603). For example, the execution unit 15e transmits a notification to a worker W2 engaging in the same work process as the worker W1, in whom the abnormality has been detected, the notification requesting the worker W2 to support the worker W1.

### 3-6-1-3. Manager Notification Process

The execution unit 15e executes a manager notification process (Step S604). For example, the execution unit 15e transmits an alarm detection notification to a manager of the worker W1, in whom the abnormality has been detected.

### 3-6-2. Second Intervention Execution Process

The execution unit 15e executes a second intervention execution process through the following flow. The second intervention determination process is a process having, as a target of intervention, a device.

### 3-6-2-1. Device Control Process

In a case where a target of intervention is a device (Step S601: intervention for device), the execution unit 15e executes a device control process (Step S605). For example, the execution unit 15e executes control to change a process value to a safer value for a device operated by the worker W1, in whom the abnormality has been detected.

### 3-6-3. Others

The execution unit 15e may execute the first execution process having, as the target of intervention, the person concerned with the work, as well as the second intervention execution process having, as the target of intervention, the device.

### 4. Effects of Embodiment

Effects of the embodiment will be described lastly. First to eighth effects corresponding to the processes according to the embodiment will be described hereinafter.

### 4-1. First Effect

Firstly, in the above described process according to the embodiment, biological data on plural workers W engaging in the same work related to operation of a plant are acquired, a state of each of the plural workers W is estimated on the basis of the biological data on the plural workers W, an analysis of the state of each of the plural workers W is made, and whether or not intervention in that shared work is necessary is determined on the basis of a result of the analysis. Therefore, the process enables presentation of an appropriate work environment according to the states of the workers W.

### 4-2. Second Effect

Secondly, in the above described process according to the embodiment, in a case where abnormality has been detected in the workers W engaging in the work, an intervention means for the plant is determined and an intervention in the plant where the shared work is carried out is executed on the basis of the intervention means. Therefore, the process enables precise detection of the abnormality according to the states of the workers W and presentation of an appropriate work environment.

### 4-3. Third Effect

Thirdly, in the above described process according to the embodiment, operation data collected from the plant devices 50 installed in the plant, work environment data related to an environment in the plant where each of the plural workers W engages in work, and work data related to work carried out by each of the plural workers W are additionally acquired and a physical or psychological state is estimated as a state of each of the plural workers W on the basis of the biological data collected from a device worn by each of the plural workers W. In a case where a ratio of workers W indicating a predetermined state to the plural workers W engaging in the same work exceeds a threshold, abnormality in the workers W is detected, an intervention means is determined by reference to correspondence relation data indicating a history of intervention in the plant and by using the state of each of the plural workers W, the operation data, the work environment data, and the work data, and a notification to a predetermined worker W1 or a person concerned with the predetermined worker W1 is made or control of a plant device is executed. Therefore, the process enables precise detection of the abnormality according to the states of the workers W and effective presentation of an appropriate work environment.

### 4-4. Fourth Effect

Fourthly, in the above described process according to embodiment, a work process of each of the plural workers W is determined by use of the work environment data and the work data and the plural workers W are classified by shared work process. Therefore, the process enables more effective presentation of an appropriate work environment according to the states of the workers W by determination of the workers W engaging in the same work process.

### 4-5. Fifth Effect

Fifthly, in the above described process according to the embodiment, a machine learning model that outputs an evaluation index for the plant in response to input of time-series data including biological data, operation data, work environment data, or work data is trained, and time evolution of an evaluation index from a time point of execution of intervention is predicted on the basis of a result obtained by input of the biological data, operation data, work environment data, or wok data changed by the execution of the intervention into the machine learning model that has been trained. Therefore, the process enables more effective presentation of an appropriate work environment according to the states of the workers W by a simulation of a situation of the plant after the intervention.

### 4-6. Sixth Effect

Sixthly, in the above described process according to the embodiment, an intervention means is determined by use of predicted time evolution of an evaluation index, from plural intervention means selected by reference to correspondence relation data. Therefore, the process enables more effective presentation of an appropriate work environment according to the states of the workers W by making a simulation of a situation of the plant after generating intervention data.

### 4-7. Seventh Effect

Seventhly, in the above described process according to the embodiment, an intervention means is determined by reference to correspondence relation data selected by use of predicted time evolution of an evaluation index. Therefore, the process enables more effective presentation of an appropriate work environment according to the states of the workers W by generating intervention data after making a simulation of a situation of the plant.

### 4-8. Eighth Effect

Eighthly, in the above described process according to the embodiment, an intervention means that has been specified is determined from plural intervention means selected by reference to correspondence relation data. Therefore, the process enables more effective presentation of an appropriate work environment according to the states of the workers W by receiving a judgment by a manager even if sufficient correspondence relation data have not been accumulated.

### System

The process procedures, control procedures, specific names, and information including various data and parameters, which have been described above and illustrated in the drawings may be optionally modified unless particularly stated otherwise.

Furthermore, the components of each apparatus/device in the drawings have been illustrated functionally and/or conceptually and are not necessarily physically configured as illustrated in the drawings. That is, specific modes of separation and integration of the apparatuses and devices are not limited to those illustrated in the drawings. Therefore, all or some of the apparatuses and devices may be functionally or physically separated or integrated in any units according to various loads and use situations.

Furthermore, all or any part of the processing functions performed in the apparatuses and devices may be implemented by a CPU and a program analyzed and executed by the CPU or may be implemented as hardware by wired logic.

### Hardware

An example of a hardware configuration of the work support server 10 that is an information processing apparatus will be described next. The other apparatuses and devices may have a similar hardware configuration. FIG. 20 is a diagram illustrating an example of the hardware configuration. As illustrated in FIG. 20, the work support server 10 has a communication device 10a, a hard disk drive (HDD) 10b, a memory 10c, and a processor 10d. Furthermore, the units illustrated in FIG. 20 are connected to one another via a bus, for example.

The communication device 10a is a network interface card, for example, and performs communication with another server. The HDD 10b stores a DB and a program that causes the functions illustrated in FIG. 2 to operate.

The processor 10d causes processes to be operated, the processes executing the functions described by reference to FIG. 2, for example, by reading, from the HDD 10b, the program that executes the same processing as the processing units illustrated in FIG. 2 and loading the program into the memory 10c. That is, these processes execute the same functions as the processing units included in the work support server 10. Specifically, the processor 10d reads the program having the same functions as the acquisition unit 15a, the classification unit 15b, the analysis unit 15c, the decision unit 15d, the execution unit 15e, the training unit 15f, the prediction unit 15g, and the display unit 15h, from the HDD 10b. The processor 10d then executes the processes that execute the same processing as the acquisition unit 15a, the classification unit 15b, the analysis unit 15c, the decision unit 15d, the execution unit 15e, the training unit 15f, the prediction unit 15g, and the display unit 15h.

The work support server 10 thus operates as an apparatus that executes various processing methods by reading and executing the program. Furthermore, the work support server 10 may implement functions that are the same as those according to the above described embodiment by reading the program from a recording medium by means of a medium reading device, and executing the program read. The program referred to herein is not necessarily executed by the work support server 10. For example, the present invention may be similarly applied to a case where another computer or server executes the program, or a case where the computer and the server execute the program in corporation with each other.

The program may be distributed via a network, such as the Internet. Furthermore, the program may be executed by being recorded in a computer-readable recording medium, such as a hard disk, a flexible disk (FD), a CD-ROM, a magneto-optical disk (MO), or a digital versatile disc (DVD), and being read from the recording medium by a computer.

The present invention has an effect of enabling an appropriate work environment to be presented according to states of workers.

What is claimed is:

1. A work support apparatus, comprising:
an acquisition unit that acquires biological data on plural workers who engage in shared work related to operation of a plant;
an analysis unit that estimates a state of each of the plural workers on the basis of the biological data on the plural workers and makes an analysis of the state of each of the plural workers; and
a decision unit that determines, on the basis of a result of the analysis by the analysis unit, whether or not intervention in the shared work by the work support apparatus is necessary.

2. The work support apparatus according to claim 1, further comprising:
an execution unit that executes intervention in the plant where the shared work is carried out, wherein
the decision unit determines an intervention means for the plant in a case where abnormality has been detected by the analysis unit, the abnormality being in a worker engaging in work, and
the execution unit executes intervention for the plant on the basis of the intervention means.

3. The work support apparatus according to claim 2, wherein
the acquisition unit further acquires operation data collected from a plant device installed in the plant, work environment data related to an environment in the plant, the environment being where each of the plural workers engages in work, and work data related to work that each of the plural workers engages in,
the analysis unit estimates a physical or psychological state as the state of each of the plural workers on the basis of the biological data collected from a device worn by each of the plural workers, and detects the abnormality in a case where a ratio of workers indicating a predetermined state to the plural workers engaging in the shared work exceeds a threshold,
the decision unit determines the intervention means by using the state of each of the plural workers, the operation data, the work environment data, and the work data, and referring to correspondence relation data indicating a history of invention in the plant, and
the execution unit makes a notification to a predetermined worker or a person concerned with the predetermined worker or executes control of the plant device, according to the intervention means determined.

4. The work support apparatus according to claim 3, further comprising:
a classification unit that determines a work process of each of the plural workers by using the work environment data and the work data and makes a classification of the plural workers by the work process shared, wherein
the analysis unit analyzes, on the basis of a result of the classification by the classification unit, a state of each of the plural workers who engage in the shared work.

5. The work support apparatus according to claim 3, further comprising:
a training unit that trains a machine learning model that outputs an evaluation index for the plant in response to input of time-series data including the biological data, the operation data, the work environment data, or the work data; and
a prediction unit that predicts, on the basis of a result obtained by input of the biological data, operation data, work environment data, or work data changed by execution of the intervention into the machine learning model that has been trained, time evolution of the evaluation index from a time point of the execution of the intervention.

6. The work support apparatus according to claim 5, wherein the decision unit determines the intervention means by using the time evolution predicted by the prediction unit, from plural intervention means selected by reference to the correspondence relation data.

7. The work support apparatus according to claim 5, wherein the decision unit determines the intervention means from a history of intervention based on the time evolution of the evaluation index predicted by the prediction unit, from plural histories of intervention included in the correspondence relation data.

8. The work support apparatus according to claim 3, wherein the decision unit determines the intervention means that has been specified, from plural intervention means selected by reference to the correspondence relation data.

9. A work support method executed by a work support apparatus, the work support method comprising:
an acquisition process of acquiring biological data on plural workers who engage in shared work related to operation of a plant;
an analysis process of estimating a state of each of the plural workers on the basis of the biological data on the plural workers and making an analysis of the state of each of the plural workers; and
a determination process of determining, on the basis of a result of the analysis made through the analysis process, whether or not intervention in the shared work by the work support apparatus is necessary.

10. A computer-readable recording medium having stored therein a work support program that causes a work support apparatus to execute a process comprising:
an acquisition step of acquiring biological data on plural workers who engage in shared work related to operation of a plant;
an analysis step of estimating a state of each of the plural workers on the basis of the biological data on the plural workers and making an analysis of the state of each of the plural workers; and
a determination step of determining, on the basis of a result of the analysis made through the analysis step, whether or not intervention in the shared work by the work support apparatus is necessary.
